(19) United States
(12) Patent Application Publication
(10) Pub. No.: US 2026/0107083 A1
(43) Pub. Date: Apr. 16, 2026

(54) FIT TEST MANAGEMENT FOR AN AUDIO PLAYBACK DEVICE

(71) Applicant: QUALCOMM Incorporated, San Diego, CA (US)

(72) Inventors: Brijesh Singh TIWARI, Bangalore (IN); Anuj DESHMUKH, Nagpur (IN); Uday DESHPANDE, Belgaum (IN)

(21) Appl. No.: 18/916,405

(22) Filed: Oct. 15, 2024

(51) Int. Cl. H04R 1/10

(52) U.S. Cl. CPC H04R 1/1091; H04R 1/1041; H04R 2460/13; H04R 2460/17

(57) ABSTRACT

A device includes a memory configured to store fit test configuration data associated with a fit test of an audio playback device. The device also includes one or more processors coupled to the memory. The one or more processors are configured to set, based on the fit test configuration data, a test performance frequency of the fit test to a first value. The one or more processors are configured to obtain activity data corresponding to an activity measurement associated with the audio playback device.

The one or more processors are also configured to set, based on the activity measurement, the test performance frequency of the fit test to a second value.

### Field

The present disclosure is generally related to managing a fit test for an audio playback device.

### DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

As wearable electronic device technology has advanced, earbuds and other in-ear wearable devices have become popular for providing immersive audio experiences to users. These wearable electronic devices, such as earbuds, may be configured to perform periodic fit tests that enable a determination of how good a fit of the earbud is within or over an ear or ear canal of a user. Based on results of the fit test, one or more settings of the earbud can be adjusted (e.g., altering coefficient(s) associated with an equalizer) such that data inconsistencies may be prevented, device reliability may be increased, and overall user experience may be enhanced due to a more pleasing immersive audio experience. Typically, a fit test for a wearable electronic device is performed at a frequency of once per 1000 milliseconds (ms). However, such frequent performance of the fit test results in significant power consumption, which can quickly drain a power supply (e.g., a battery) of an earbud or other wearable device. Although performing the fit test at a lower frequency can reduce power consumption, a target user audio experience may degrade due to improper fit of the wearable device within an ear of the user between performances of the fit test.

### SUMMARY

According to one implementation of the present disclosure, a device includes a memory configured to store fit test configuration data associated with a fit test of an audio playback device. The device also includes one or more processors coupled to the memory. The one or more processors are configured to set, based on the fit test configuration data, a test performance frequency of the fit test to a first value. The one or more processors are also configured to obtain activity data corresponding to an activity measurement associated with the audio playback device. The one or more processors are configured to set, based on the activity measurement, the test performance frequency of the fit test to a second value.

According to another implementation of the present disclosure, a method includes setting, by one or more processors and based on fit test configuration data associated with a fit test of an audio playback device, a test performance frequency of the fit test to a first value. The method also includes obtaining, by the one or more processors, activity data corresponding to an activity measurement associated with the audio playback device. The method includes setting, by the one or more processors based on the activity measurement, the test performance frequency of the fit test to a second value.

According to another implementation of the present disclosure, a non-transitory computer-readable medium stores instructions that are executable by one or more processors to cause the one or more processors to set, based on fit test configuration data associated with a fit test of an audio playback device, a test performance frequency of the fit test to a first value. The instructions also cause the one or more processors to obtain activity data corresponding to an activity measurement associated with the audio playback device. The instructions cause the one or more processors to set, based on the activity measurement, the test performance frequency of the fit test to a second value.

According to another implementation of the present disclosure, an apparatus includes means for setting, based on fit test configuration data associated with a fit test of an audio playback device, a test performance frequency of the fit test to a first value. The apparatus also includes means for obtaining activity data corresponding to an activity measurement associated with the audio playback device. The apparatus includes means for setting, based on the activity measurement, the test performance frequency of the fit test to a second value.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

FIG. 1 is a block diagram of a particular illustrative aspect of a system including a device operable to support activity-based fit test management, in accordance with some examples of the present disclosure.

FIG. 2 includes a graph of fit test performance and fit test configuration information, in accordance with some examples of the present disclosure.

FIG. 3 is a diagram of an example of an integrated circuit operable to support activity-based fit test management, in accordance with some examples of the present disclosure.

FIG. 4 is a diagram of a mobile device operable to support activity-based fit test management, in accordance with some examples of the present disclosure.

FIG. 5 is a diagram of a headset operable to support activity-based fit test management, in accordance with some examples of the present disclosure.

FIG. 6 is a diagram of a wearable electronic device operable to support activity-based fit test management, in accordance with some examples of the present disclosure.

FIG. 7 is a diagram of a voice-controlled speaker system operable to support activity-based fit test management, in accordance with some examples of the present disclosure.

FIG. 8 is a diagram of a headset, such as a virtual reality, mixed reality, or augmented reality headset, operable to support activity-based fit test management, in accordance with some examples of the present disclosure.

FIG. 9 is a diagram of a mixed reality or augmented reality glasses device operable to support activity-based fit test management, in accordance with some examples of the present disclosure.

FIG. 10 is a diagram of earbuds operable to support activity-based fit test management, in accordance with some examples of the present disclosure.

FIG. 11 is a diagram of a hearing aid device operable to support activity-based fit test management, in accordance with some examples of the present disclosure.

FIG. 12 is a diagram of an example of a vehicle operable to support activity-based fit test management, in accordance with some examples of the present disclosure.

FIG. 13 is a diagram of a particular example of a method of activity-based fit test management, in accordance with some examples of the present disclosure.

FIG. 14 is a block diagram of a particular illustrative example of a device that is operable to support activity-based fit test management, in accordance with some examples of the present disclosure.

### DETAILED DESCRIPTION

Systems, devices, apparatus, methods, and computer-readable media for activity-based fit management for wearable audio playback devices are disclosed. Wearable audio playback devices, such as earbuds and hearing aid devices, are able to provide immersive audio experiences, in particular due to adaptive adjustment of audio output parameters (e.g., equalizer coefficients) based on a fit test of the audio playback device. The fit test may be performed periodically to test a fit of the audio playback device within or over an ear of the user or over an ear canal of the user. However, repeated performance of the fit test can quickly drain a battery of the audio playback device. By setting a frequency of a fit test for an audio playback device based on an activity measurement that is associated with the audio playback device, the disclosed techniques provide adaptive determinations of whether to adjust audio output parameters based on device fit with reduced power consumption as compared to periodic performance of the fit test by other audio playback devices.

To illustrate performance of activity-based fit test management, an audio playback device may be configured to perform a fit test to determine a fit of the audio playback device (e.g., such as within or over an ear of a user). For example, performance of the fit test may generate a result that can be used to adjust audio output parameter(s), such as equalizer coefficients, to improve the immersive experience associated with output audio from the audio playback device for a particular user. As an illustrative example, the audio playback device may adjust the audio output to compensate for any mismatch between the size or shape of the audio playback device and the size or shape of the user's ear, thereby improving the user's audio experience. In some aspects, a test performance frequency of the fit test is set to a first value based on fit test configuration data associated with a fit test. For example, the first value may be an initial value or a value that results from an initial performance of the fit test. Additionally, activity data corresponding to an activity measurement associated with the audio playback device may be obtained. For example, the activity sensor(s) (e.g., an inertial measurement unit (IMU)) may generate activity data that represents movement of the audio playback device, a change in orientation of the audio playback device, or another type of activity measurement associated with the audio playback device. In some aspects, based on the activity measurement, the test performance frequency of the fit test to a second value. For example, if the activity measurement indicates that activity of the audio playback device has increased, the test performance frequency is set to a higher frequency. However, if the activity measurement indicates that the activity of the audio playback device has decreased, the test performance frequency can be set to a lower frequency.

In some aspects, a control link is incorporated between a fit test manager (e.g., an audio component within, or executed by, a processor of the audio playback device) and an application layer, and another control link is implemented between the IMU and the application layer. For example, the fit test manager and the IMU (or other activity sensors) may be configured to receive control inputs and to generate control outputs at the application layer in addition to lower layers of an execution stack at the audio playback device. Additionally, a data link may be incorporated between the fit test manager and the IMU to enable activity data (e.g., IMU data) or other data to be communicated between the two components. These control and data links enable the IMU to determine real-time user activity levels and motion patterns of the user (e.g., activity levels and motion patterns associated with the audio playback device) and to convey the determined activity data to the fit test manager via the application layer. The fit test manager can determine, based on the received activity data, the test performance frequency that achieves a target balance between providing adaptive fit-based audio outputs and reducing power consumption. As an illustrative example, if the activity data indicates an activity level that satisfies an activity threshold, the fit test manager may set the test performance frequency to once per 1000 ms, and if the activity level fails to satisfy the threshold, the fit test manager may set the test performance frequency to once per 2000 ms. In other examples, more than two fit test performance frequencies may be possible based on comparison of the activity level to more than one activity threshold (or to one or more threshold ranges).

In some embodiments, additional power saving may be achieved by deactivating one or more components of the audio playback device during some time periods. To illustrate, a feedback microphone that is used during the fit test may be one of the most power-intensive components that is active during the fit test. Because the feedback microphone (or other components) remain active regardless of whether the fit test is being performed, these component(s) consume power during time periods when they are not being used to perform the fit test, such as during idle time periods between fit tests. For example, if the test performance frequency is once per 4000 ms, and the duration of the fit test is 500 ms, one or more components (e.g., the feedback microphone, the fit test manager, etc.) may be active for a prolonged idle period (e.g., 3500 ms) even though no operations are being performed by the fit test manager. Accordingly, the feedback microphone, the fit test manager, other component(s), or a combination thereof, may be deactivated during idle time periods between consecutive performances of the fit test. In some examples, the application layer may provide control signals over the control links to the feedback microphone and the fit test manager to cause these (or other) components to be deactivated after performance of the fit test and subsequently reactivated prior to performance of the next fit test, thereby conserving additional power as compared to when such components remain active between each fit test.

Thus, the aspects described herein support activity-based fit test management for wearable audio playback devices in a power-aware manner. A technical benefit of the disclosed aspects is a fit test for an audio playback device that is associated with reduced power consumption as compared to other fit tests of other audio playback devices. To illustrate, during time periods in which high levels of activity are detected with respect to the audio playback device, the test performance frequency may be set to a relatively high frequency, similar to other fit tests, in order to maintain the improved and user-specific audio experience associated with performance of the fit test. However, during time periods in which lower levels of activity are detected with respect to the audio playback device, the test performance frequency may be set to a lower frequency to decrease the number of times the fit test is performed, thereby reducing power consumption associated with performance of the fit test. Reducing the power consumption associated with the fit test increases the battery life of the audio playback device, thereby improving the overall user experience by lengthening the time between charging, as well as providing the improved immersive audio experience of user-specific audio output levels that result from selective performance of the fit test.

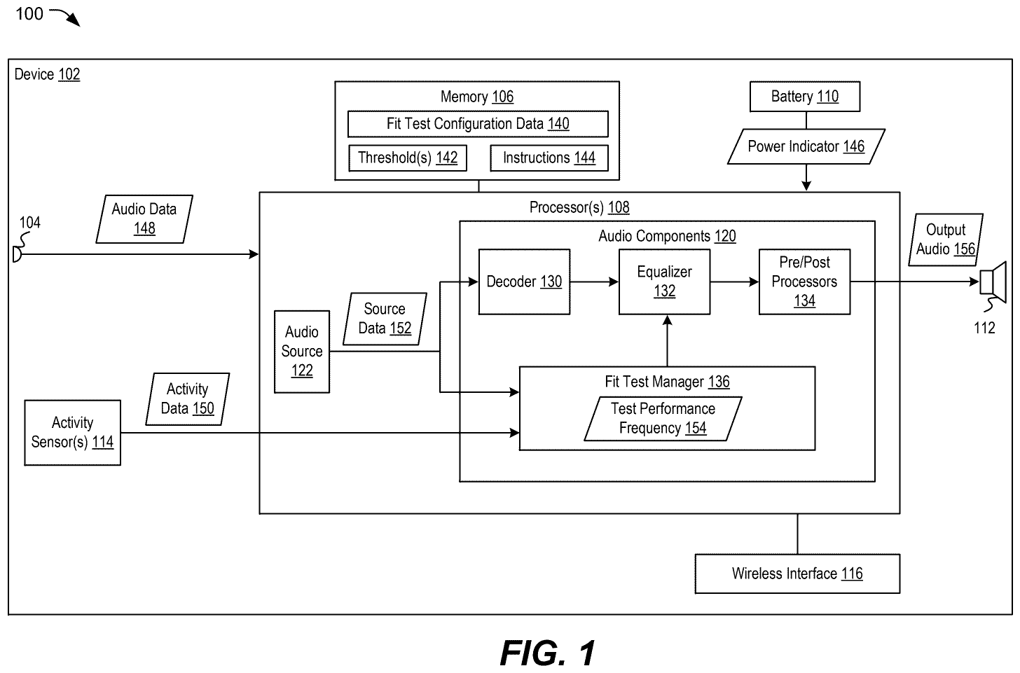

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 108 of FIG. 1), which indicates that in some implementations the device 102 includes a single processor 108 and in other implementations the device 102 includes multiple processors 108. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein—e.g., when no particular one of the features is being referenced, the reference number is used without a distinguishing letter. However, when one particular feature of multiple features of the same type is referred to herein, the reference number is used with the distinguishing letter. For example, referring to FIG. 10, multiple earbuds are illustrated and associated with reference numbers 1002A and 1002B. When referring to a particular one of these earbuds, such as a first earbud 1002A, the distinguishing letter “A” is used. However, when referring to any arbitrary one of these earbuds or to these earbuds as a group, the reference number 1002 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

FIG. 1 shows a block diagram of a particular illustrative aspect of a system 100 including a device 102 operable to support activity-based fit test management, in accordance with some examples of the present disclosure. The system 100 includes the device 102 that is operable to manage performance of a fit test based on activity data 150, as further described below.

The device 102 includes one or more microphones 104 (collectively referred to herein as a “microphone 104”), a memory 106, one or more processors 108 (collectively referred to herein as a “processor 108”), a battery 110, one or more speakers 112 (collectively referred to herein as a “speaker 112”), one or more activity sensors 114 (collectively referred to herein as an “activity sensor 114”), and a wireless interface 116. The device 102 may include or correspond to a wearable audio playback device, such as an earbud, a hearing aid device, a headset device with one or more pieces or portions that are configured to be worn within an ear of a user, headphones or a headset that are worn over an ear of a user, or another type of audio playback device that is worn in or over an ear of a user. Alternatively, the device 102 may include or correspond to an electronic device, such as a mobile phone, that is communicatively coupled to such a wearable audio playback device. Although multiple components are illustrated in and described with reference to FIG. 1, in other embodiments, the device 102 may include fewer components, more components, or different components than shown and described with reference to FIG. 1. As an example, the wireless interface 116 may be optional, which means in some embodiments the device 102 does not include the wireless interface 116, or the wireless interface 116 may be replaced with a modem. As another example, in some embodiments in which the device 102 is not the audio playback device, the microphone 104, the battery 110, the speaker 112, the activity sensor 114, or a combination thereof are optional, which means that in at least some embodiments the device 102 does not include the microphone 104, the battery 110, the speaker 112, the activity sensor 114, or a combination thereof, and in at least some other embodiments, the device 102 includes the microphone 104, the battery 110, the speaker 112, the activity sensor 114, or a combination thereof.

The microphone 104 is coupled to the processor 108 and configured to generate audio data 148 based on sound detected from an audio environment (e.g., an ambient environment of the device 102). In some aspects, the microphone 104 includes one or more different types of microphones. For example, the microphone 104 may include a feedback microphone that is configured to capture sounds output by the speaker 112. As another example, the microphone 104 can include a bone conduction microphone that is configured to detect vibrations transmitted through bone(s) of a user. The sounds detected by the microphone 104 can include music or other audio content output by the speaker 112, voice output by the speaker 112 (e.g., from a call, a teleconference, etc.), speech, sounds in an environment around the user, noise, other sounds, or a combination thereof. In some aspects, the audio data 148 can represent an audio signal, or samples thereof, that is captured during performance of a fit test associated with an audio playback device (e.g., the device 102).

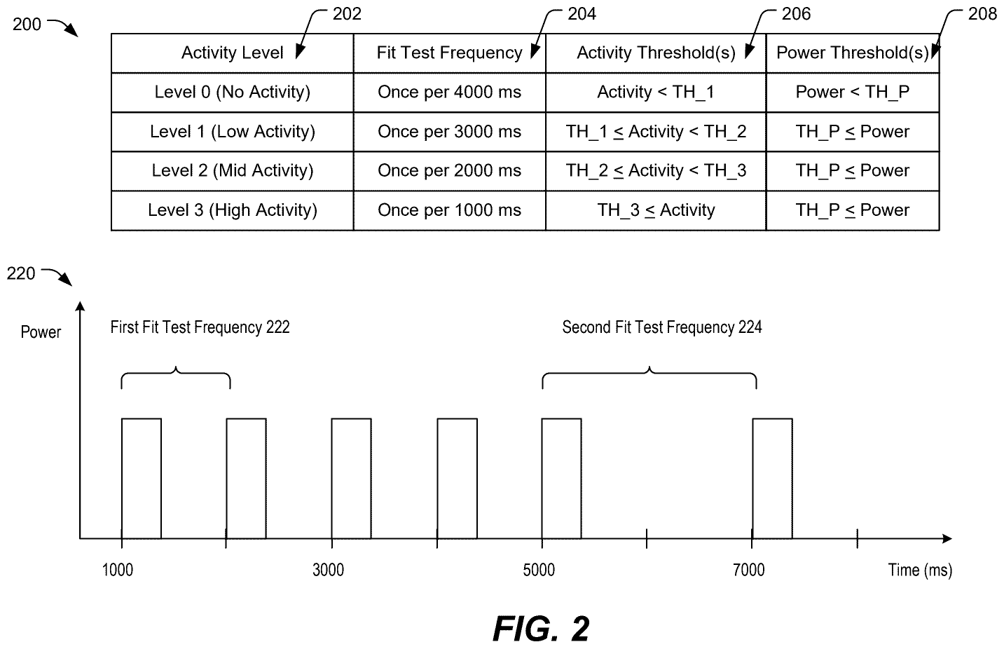

The memory 106 is configured to store fit test configuration data 140 and one or more thresholds 142 (referred to herein collectively as “thresholds 142”). The fit test configuration data 140 can include or represent parameters associated with a fit test associated with an audio playback device (e.g., the device 102 or an external audio playback devices that is communicatively coupled to the device 102). For example, the fit test configuration data 140 may include or represent multiple activity levels that correspond to multiple test performance frequency values, as further described with reference herein to FIG. 2. The thresholds 142 may include one or more activity thresholds that are associated with the activity levels represented or indicated by the fit test configuration data 140, one or more power thresholds, one or more fit thresholds associated with the fit test, other thresholds, or a combination thereof. In some examples, the memory 106 also includes or stores instructions 144 that, when executed by the processor 108, cause the processor 108 to perform one or more operations as described herein. In some examples, the memory 106 stores other information or data, such as measured power values, measured activity data, fit test results, audio data, one or more user preferences, or the like.

In FIG. 1, processor 108 (e.g., the device 102) is coupled to one or more audio sources 122 (referred to herein collectively as an “audio source 122”). In some embodiments, the audio source 122 is integrated within the device 102. For example, the audio source(s) 122 can include media files stored in the memory 106. As another example, the audio source 122 can include one or more microphones integrated within or coupled to the device 102, such as the microphone 104. Additionally, or alternatively, the audio source 122 can include media data or audio data received from another device, such as via the wireless interface 116.

The processor 108 includes audio components 120 that include a decoder 130, an equalizer 132, pre-processors and/or post-processors 134 (referred to herein collectively as “pre/post processors 134”), and a fit test manager 136. Although shown in FIG. 1 as being included in the audio components 120, in some other embodiments, the fit test manager 136 is separate from the audio components 120. Each of the decoder 130, the equalizer 132, the pre/post processors 134, the fit test manager 136, or a portion thereof, may be implemented by the processor 108 executing instructions (e.g., software), dedicated hardware (e.g., circuitry), or a combination thereof. The decoder 130 is configured to decode input audio data, such as source data 152 from the audio source 122, into one or more audio signals for output at the speaker 112. The equalizer 132 is configured to adjust the loudness (e.g., set a level) of one or more frequency ranges for an audio signal. For example, the equalizer 132 may be configured to set one or more levels associated with one or more frequency ranges of audio signals to be output by the speaker 112. In some aspects, the equalizer 132 is configured to set one or more levels of audio signal(s) based on results of a fit test that is managed by the fit test manager 136, as further described herein. The pre/post processors 134 are configured to perform pre-processing operation(s), post-processing operation(s), or a combination thereof, on input audio data or audio signals prior to generation of an output signal, such as output audio 156, for output by the speaker 112. For example, the pre/post processors 134 may be configured to perform a resampling operation, a filtering operation, a conversion operation (e.g., from a first format to a second format), a compression operation, an expansion operation, a reverb operation, a delay operation, another pre-processing or post-processing operation, or a combination thereof.

The fit test manager 136 is configured to manage performance of a fit test for the device 102. The fit test is designed to provide adaptive equalization of audio signals based on the fit of the device 102 (e.g., an in-ear audio playback device, such as an earbud, a hearing aid device, etc.) to provide a high quality immersive audio experience regardless of the type of audio playback device or the fit of the audio playback device within or over the user's ear. To illustrate, the fit test may include the fit test manager 136 initiating output of a reference sound via the speaker 112 and initiating capture of an input audio signal, via the microphone 104, that corresponds to the reference sound as heard within the user's ear. Based on a difference between the input audio signal and the reference sound, the fit test manager 136 may determine one or more adjustments to the equalizer 132 (e.g., one or more equalizer coefficient adjustments) to be performed to reduce a difference between the input audio signal and the reference sound. In this manner, the fit test manager 136 is configured to adaptively adjust output audio parameters (e.g., coefficients associated with the equalizer 132) to account for any mismatch with the fit of the audio playback device (e.g., the device 102) within the user's ear, over the ear canal, or between an earphone and the ear. Because the fit test is performed adaptively once the device 102 is within or over the user's ear (or ear canal), the resulting adjustments are personalized to each user instead of being based on a predetermined user templates, and the fit test can be performed automatically without the user providing ear measurements or ensuring an optimum fit between the device 102 and the user's ear. To compensate for any changes to the fit between the device 102 and the user's ear during use (e.g., due to movement of the user, adjustment of the position of the device 102, etc.), the fit test manager 136 is configured to repeatedly perform the fit test according to a test performance frequency 154 associated with the fit test. As used herein, the test performance frequency 154 refers to the frequency in time with which the fit test is performed, such as once every 1000 ms, once every 2000 ms, etc., as non-limiting examples.

The fit test manager 136 is also configured to adaptively set the test performance frequency 154 during operation of the device 102. To illustrate, the fit test manager 136 is configured to set the test performance frequency 154 to a first value for a first time period, with the first value being based on an initial frequency (e.g., indicated by the fit test configuration data 140), a frequency determined during an initial, or previous, fit test, a fit test based on a power level of the battery 110, or the like. The fit test manager 136 is also configured to set the test performance frequency 154 to a second value for a second time period, such that the test performance frequency 154 may be modified (e.g., changed from the first value to the second value) for different time periods and based on one or more conditions. In some aspects, the fit test manager 136 is configured to set the test performance frequency 154 based on an activity measurement indicated by the activity sensor 114, as further described herein. Additionally, or alternatively, the fit test manager 136 may be configured to set the test performance frequency 154 based on other conditions, such as a power level of the battery 110, a user input, or the like, as further described herein.

The battery 110 is coupled to one or more components of the device 102 and configured to provide power to the one or more components. To illustrate, the battery 110 is coupled to, and configured to provide power to, the microphone 104, the memory 106, the processor 108, the speaker 112, the activity sensor 114, and the wireless interface 116. In some examples, the device 102 includes a sensor that is configured to monitor the battery 110 and generate power information, such as a power indicator 146. The power indicator 146 may indicate the power level of the battery 110.

The speaker 112 is coupled to the processor 108 and configured to play back (e.g., output) the output audio 156. In some aspects, the output audio 156 that is output by the speaker 112 may be based on an output of the audio components 120 (e.g., the pre/post processors 134), such that the output audio is adapted based on a result of the fit test to improve a quality of the audio, an audio experience for the user, or both.

The activity sensor 114 is coupled to the processor and configured to generate the activity data 150 that indicates one or more activity measurements associated with the device 102. For example, the activity data 150 may indicate motion of the device 102, a change in orientation of the device 102, detected vibrations that correspond to activity of the device 102, other types of activity, or a combination thereof. In some aspects, the activity sensor 114 includes an inertial measurement unit (IMU) that is configured to measure acceleration of the device 102, rotation of the device 102, velocity of the device 102, or a combination thereof. As an example, the IMU (e.g., the activity sensor 114) may be configured to measure an acceleration of the device 102 and a displacement of the device 102 with respect to multiple reference axes (e.g., an x-axis, a y-axis, and a z-axis). Additionally, or alternatively, the activity sensor 114 may include a bone conduction microphone that is configured to detect vibrations transmitted through bone(s) of a user, and the vibrations may be representative of, or used to derive a value of, motion or other activity associated with the device 102.

The wireless interface 116 is coupled to the processor 108 and configured to send data to, receive data from, or both, one or more devices that are communicatively coupled to the device 102. The wireless interface 116 may be configured to communicate according to one or more wireless communication standards or techniques, and may include or correspond to a Wi-Fi interface, a Bluetooth interface, a Zigbee interface, a near-field communication (NFC) interface, or another type of wireless communication interface. In embodiments in which the device 102 is configured to communicate via one or more cellular communication networks, the wireless interface 116 may be replaced with, or the device 102 may also include, a modem configured to communicate with one or more devices via the cellular communication network(s). In some aspects, the wireless interface 116 is configured to receive audio data from another device, receive user input data from another device, receive activity data from another device, transmit the output audio 156 or the test performance frequency 154 to another device, receive the test performance frequency 154 from another device, or a combination thereof.

During operation of the system 100, the device 102 outputs audio to a user, such as by playback of music, media content, a phone call, a voice conference application output, an artificial intelligence (AI)-generated audio output, another audio output, or a combination thereof. For example, the device 102 may be a wearable audio playback device (e.g., an earbud, a hearing aid device, a headset device with at least one piece or portion that is worn within the user's ear, a headphone, etc.) that is worn in or over the user's ear and that outputs audio content to the user. The device 102 also performs a fit test to adaptively determine whether to adjust one or more audio output parameters (e.g., coefficients associated with the equalizer 132) based on a fit of the device 102 within or over the user's ear. To illustrate, the fit test manager 136 may initiate performance of the fit test (e.g., at a time indicated by the test performance frequency 154), and the audio components 120 may perform one or more operations of the fit test.

As an example of the fit test, the processor 108 may obtain the source data 152 from the audio source 122 and provide the source data 152 to the audio components 120 for processing by the decoder 130, the equalizer 132, and the pre/post processors 134 to generate the output audio 156 that is output by the speaker 112. In this example, the source data 152 corresponds to a reference audio signal (e.g., a test signal associated with the fit test), the audio source 122 corresponds to the memory 106, and the output audio 156 is audio corresponding to the source data 152. As the speaker 112 outputs the audio corresponding to the reference audio signal, the microphone 104 (e.g., a feedback microphone) captures the audio being outputted as the audio data 148, and the audio data 148 is provided to the fit test manager 136 to compare to the source data 152. As part of the fit test, the fit test manager 136 compares the audio data 148 to the source data 152 to determine whether or not to adjust the equalizer 132 to cause the audio data 148 to more closely match the source data 152. For example, the fit test manager 136 may adjust one or more equalizer coefficients of the equalizer 132 to adjust output levels associated with different frequencies to compensate for any mismatch in fit between the device 102 and the user's ear. Other operations may also be performed by the processor 108 (e.g., the fit test manager 136) to cause the audio data 148 from the feedback microphone (e.g., the microphone 104) to more closely match the reference audio signal (e.g., the source data 152, in this example).

Because the fit of the device 102 within or over the user's ear may change over time, the fit test manager 136 initiates performance of the fit test during operation of the device 102 according to the test performance frequency 154. However, repeatedly performing the fit test can consume power and/or reduce a stored power level of the battery 110. Accordingly, the fit test manager 136 may adaptively modify the test performance frequency 154 based on one or more conditions, such as activity of the device 102, in order to reduce power consumption associated with performance of the fit test without substantially sacrificing one or more benefits based on the fit test, such as an improved immersive audio experience and user personalization. For example, the fit test manager 136 may determine whether to adjust (e.g., modify) the test performance frequency 154 based on an activity of the device 102, a power level associated with the battery 110, a user input, another condition, or a combination thereof, such that the test performance frequency 154 is decreased in situations in which the fit of the device 102 in or over the user's ear is less likely to change and the test performance frequency 154 is increased in situations in which the fit of the device 102 in or over the user's ear is more likely to change.

In some aspects, the fit test manager 136 controls (e.g., sets or modifies) the test performance frequency 154 based on activity of the device 102. To illustrate, the fit test manager 136 may be configured to set, based on the fit test configuration data 140 that is associated with the fit test, the test performance frequency 154 to a first value. For example, the first value may be an initial frequency value that is indicated by the fit test configuration data 140 and that corresponds to a default or baseline frequency for performance of the fit test (e.g., a default or baseline amount of time between performances of the fit test). In some aspects, the fit test configuration data 140 may indicate a plurality of test performance frequency values and a plurality of activity levels, and each test performance frequency value is associated with a corresponding activity level indicated by the fit test configuration data 140. In a particular example, the first value corresponds to a test performance frequency value associated with a lowest activity level. In other examples, the first value corresponds to a different activity level indicated by the fit test configuration data 140. Additional details and examples of the fit test configuration data 140 are described further herein with reference to FIG. 2.

As the device 102 is used to play audio, the processor 108 obtains the activity data 150 that corresponds to an activity measurement associated with the device 102 (e.g., the audio playback device). To illustrate, the activity sensor 114 may be configured to detect activity associated with the device 102 and to generate the activity data 150 that represents or indicates the detected activity, such as motion of the device 102, an orientation of the device 102 (or a change in the orientation), a velocity of the device 102, an acceleration of the device 102, vibrations of the device 102, other types of detected activity, or a combination thereof. As an example, the activity sensor 114 includes an IMU and the activity data 150 includes motion data output by the IMU, such as acceleration of the device 102, rotation of the device 102, velocity of the device 102, or a combination thereof. As another example, the activity sensor 114 can include a bone conduction microphone and the activity data 150 can include audio data that is output by the bone conduction microphone and that indicates vibrations that correspond to motion of the device 102.

To enable sharing of the activity data 150, a data link may be implemented between the fit test manager 136 and the activity sensor 114, and fit test manager 136 may receive the activity data 150 from the activity sensor 114 via the data link. In some examples, the data link is a robust unidirectional link between the upstream and downstream modules (e.g., from the activity sensor 114 to the fit test manager 136) to enable seamlessly sharing and transferring of data and metadata, thereby ensuring efficient and reliable communication between the components. Additionally, a control link may be implemented between the fit test manager 136 and an application layer of the processor 108, as well as a control link between the activity sensor 114 (e.g., the IMU or an Inertial Measurement Module (IMM)) and the application layer. In some examples, the control links are bidirectional links configured for inter-module communication, facilitating the transfer of non-data elements, such as commands, control signals, and system-level instructions, between the application layer and the fit test manager 136, between the application layer and the activity sensor 114, or both. The control signals (or other commands or instructions) may facilitate the sharing of the activity data 150, enable selective deactivation of the fit test manager 136 (and other components), or a combination thereof.

In some aspects, the processor 108 is configured to continuously obtain the activity data 150 from the activity sensor 114 during operation of the device 102. For example, the activity sensor 114 may be configured to continuously sense activity of the device 102 while the activity sensor 114 is activated. In such an example, the activity data 150 represents real time or near-real time activity measurements associated with the device 102. In some other aspects, the processor 108 is configured to periodically obtain the activity data 150 from the activity sensor 114 according to a polling schedule. For example, to conserve power, the fit test manager 136 may poll the activity sensor 114 at designated times to receive the activity data 150, and the activity data 150 may indicate a change in activity of the device 102 since the most recent polling (e.g., the activity data 150 may represent an activity delta). The polling schedule may be fixed (e.g., static) or dynamic. As an example, a dynamic polling schedule may be modified based on historical activity data, such as be increasing the polling schedule if a threshold level of activity is detected or decreasing the poling schedule if the threshold level of activity is not detected. In some aspects, the polling schedule may have the same or different frequency as the test performance frequency 154. For example, the polling schedule may indicate to poll the activity sensor 114 more frequently, or less frequently, than performance of the fit test according to the test performance frequency 154.

After obtaining the activity data 150, the fit test manager 136 may set, based on the activity measurement indicated by the activity data 150, the test performance frequency 154 to a second value. The second value may be a second performance frequency value that is different than the first value and that compensates for changes in the activity of the device 102. To determine the second value, the fit test manager 136 may compare the activity measurement indicated by the activity data 150 to one or more activity thresholds (e.g., the thresholds 142) and select a test performance frequency value from the fit test configuration data 140. To illustrate, the activity thresholds of the thresholds 142 may represent boundaries between the activity levels indicated by the fit test configuration data 140, and the processor 108 (e.g., the fit test manager 136) may select a current activity level from the indicated activity levels based on the comparison of the activity measurement to the activity threshold(s). Each of the activity levels is associated with a respective test performance frequency value, as indicated by the fit test configuration data 140, and the fit test manager 136 may set the test performance frequency 154 based on the associated test performance frequency value for the current activity level. For example, the fit test configuration data 140 may indicate that a first activity level is associated with a first test performance frequency value (e.g., the first value), a second activity level is associated with a second test performance frequency value (e.g., the second value) that is greater than the first test performance frequency value, the first activity level is associated with activity measurements that fail to satisfy a first threshold (of the thresholds 142), and the second activity level is associated with activity measurements that satisfy (e.g., are greater than or equal to) the first threshold. In this example, the fit test manager 136 may select the current activity level as the second activity level if the activity measurement satisfies the first threshold, and based on this comparison, the fit test manager 136 may set the test performance frequency 154 as the second value (e.g., the second test performance frequency value that is associated with the second activity level). Additional examples of determining the current activity level and the value of the test performance frequency 154 are further described here with reference to FIG. 2.

In some aspects, the fit test manager 136 controls the test performance frequency 154 based on other conditions. As an example, the fit test manager 136 may set or modify the test performance frequency 154 based on a power level associated with the battery 110. In some aspects, the fit test manager 136 may obtain data corresponding to a power level of the device 102 (e.g., an indication of an amount or capacity of power of the battery 110) for use in setting the test performance frequency 154. To illustrate, the processor 108 may receive the power indicator 146 that includes or indicates the power level of the battery 110. In some examples, the device 102 includes a sensor that is configured to monitor the battery 110 and generate power information, such as the power indicator 146. In some aspects, the processor 108 includes an application layer that is configured to receive the power information or the power indicator 146 and provide the power indicator 146 to the fit test manager 136. In some examples, the processor 108 (e.g., the application layer or the fit test manager 136) can detect a power level, such as a battery level of the battery 110, and the fit test manager 136 can set the test performance frequency 154 to a lower frequency value to reduce power consumption associated with performing the fit test. For example, if the power indicator 146 indicates a power level that is lower than a power threshold of the thresholds 142, the fit test manager 136 may set the test performance frequency to a third value that is less than the second value to decrease the number of times the fit test is performed, thereby reducing the power consumption. In some examples, if the power level is lower than a second power threshold (of the thresholds 142), the fit test manager 136 may be deactivated (or temporarily stop performance of the fit test) until the power level is greater than the second power threshold.

As another example, the fit test manager 136 may set or modify the test performance frequency 154 based on user input. To illustrate, the processor 108 may receive user input (e.g., via the wireless interface 116 or from a user interface (not shown)) that indicates a user-selected frequency value. The fit test manager 136 may set the test performance frequency 154 based on the user-selected frequency value. For example, fit test manager 136 may change the test performance frequency 154 from a current value to the user-selected frequency value, or to a nearest permissible test performance frequency value.

After setting, modifying, or adjusting the test performance frequency 154, the processor 108 performs the fit test according to the test performance frequency 154. For example, if the test performance frequency 154 is set to the second value that is greater than the first value, the fit test manager 136 may initiate performance of the fit test more often (e.g., due to detected activity which may have caused the device 102 to shift within the user's ear, and as such, performing the fit test more frequently may be beneficial). As another example, if the test performance frequency 154 is set to the first value that is less than the second value, the fit test manager 136 may initiate performance of the fit test less often (e.g., due to less, or a lack of, detected activity which is less likely to shift the device 102 within the user's ear). In this manner, the fit test manager 136 may determine whether to adjust the test performance frequency 154 to increase or decrease the frequency with which the fit test is performed based on one or more conditions, such as activity of the device 102 or the power level of the battery 110.

In some aspects, the processor 108 is configured to reduce power consumption between consecutive performances of the fit test by deactivating or bypassing one or more components associated with the fit test during idle periods between consecutive performances of the fit test. For example, the fit test may be performed during a first period associated with a first performance of the fit test and during a second time period associated with a second performance of the fit test, and one or more components may be deactivated for an idle time period between the first time period and the second time period. In some examples, the one or more components that are deactivated include the feedback microphone (e.g., the microphone 104), the fit test manager 136, the activity sensor 114, other components of the device 102 that are used for the fit test, or a combination thereof. As an illustrative example, if the first time period and the second time period are each 500 ms, the first time period begins at 0 ms, and the second time period begins at 1000 ms, the processor 108 may deactivate the component(s) during an idle time period between 500 ms and 1000 ms. Similarly, the processor 108 may deactivate the component(s) during idle time periods that occur between consecutive performances of the fit test, such as between the second performance during the second time period and a third performance during a third time period, etc.

In some aspects, the control links between the application layer and the fit test manager 136, between the application layer and the activity sensor 114, and between the application layer and the microphone 104 (e.g., the feedback microphone), enable the application layer to provide control signaling to the components to cause deactivation of the components during the idle time periods. Because the microphone 104 may be one of the more power-intensive components of the device 102 that is used to perform the fit test, disabling the microphone 104 (e.g., the feedback microphone), and optionally the fit test manager 136 or the activity sensor 114, during idle time periods may reduce a drain on the battery 110. In some embodiments, deactivating the microphone 104 (or the microphone 104 and the fit test manager 136) during idle time periods may reduce power consumption by nearly 20% and result in extending a use of the battery 110. In some aspects, the activity sensor 114 is not disabled during the idle time periods such that the activity sensor 114 can continue to detect motion of the device 102 during the idle time periods.

Examples above have been primarily described for aspects of the disclosure in which the device 102 is a wearable audio playback device, such as an earbud, a hearing aid device, or a headset device. In some other aspects, the device 102 is not the audio playback device (e.g., the audio playback device is external to and distinct from the device 102) and instead is communicatively coupled to the audio playback device via the wireless interface 116. In such aspects, the device 102 may perform some of the operations described above based on communicating with the audio playback device. For example, the microphone 104, the activity sensor 114, the battery 110, and the speaker 112 may be included in the audio playback device, the audio components 120 (and the fit test manager 136 in embodiments in which the fit test manager 136 is separate from the audio components 120) may be included in the device 102, and the device 102 may receive the audio data 148, the activity data 150, and the power indicator 146 from the audio playback device via the wireless interface 116. Alternatively, the device 102 may be a smart phone, a smart watch, or another type of device that includes the activity sensor 114, and the audio playback device may not include activity sensor(s). The device 102 may determine the test performance frequency 154 based on the activity data 150, and optionally the power indicator 146, and the device 102 may transmit the test performance frequency 154 to the audio playback device via the wireless interface 116. Additionally, to perform the fit test, the device 102 may generate the output audio 156 and transmit the output audio 156 to the audio playback device for playing out to the user, and the device 102 may receive the audio data 148 from the audio playback device and determine whether to adjust one or more output audio parameters (e.g., the equalizer coefficients associated with the equalizer 132) based on the audio data 148 and the source data 152. In these examples, the device 102 and the audio playback device may be configured to operate as a distributed audio playback system that performs activity-based fit tests.

In a particular example, the device 102 includes a memory (e.g., the memory 106) configured to store fit test configuration data (e.g., the fit test configuration data 140) associated with a fit test of an audio playback device (e.g., the device 102). The device 102 also includes one or more processors (e.g., the processor 108) coupled to the memory. The one or more processors are configured to set, based on the fit test configuration data, a test performance frequency (e.g., the test performance frequency 154) of the fit test to a first value. The one or more processors are also configured to obtain activity data (e.g., the activity data 150) corresponding to an activity measurement associated with the audio playback device. The one or more processors are also configured to set, based on the activity measurement, the test performance frequency of the fit test to a second value.

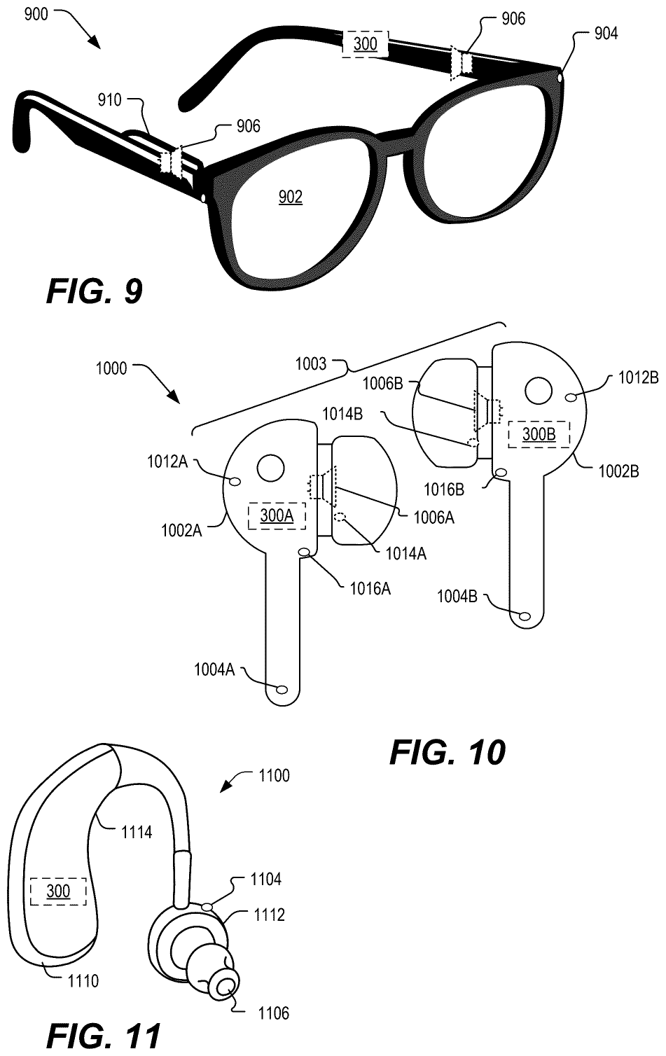

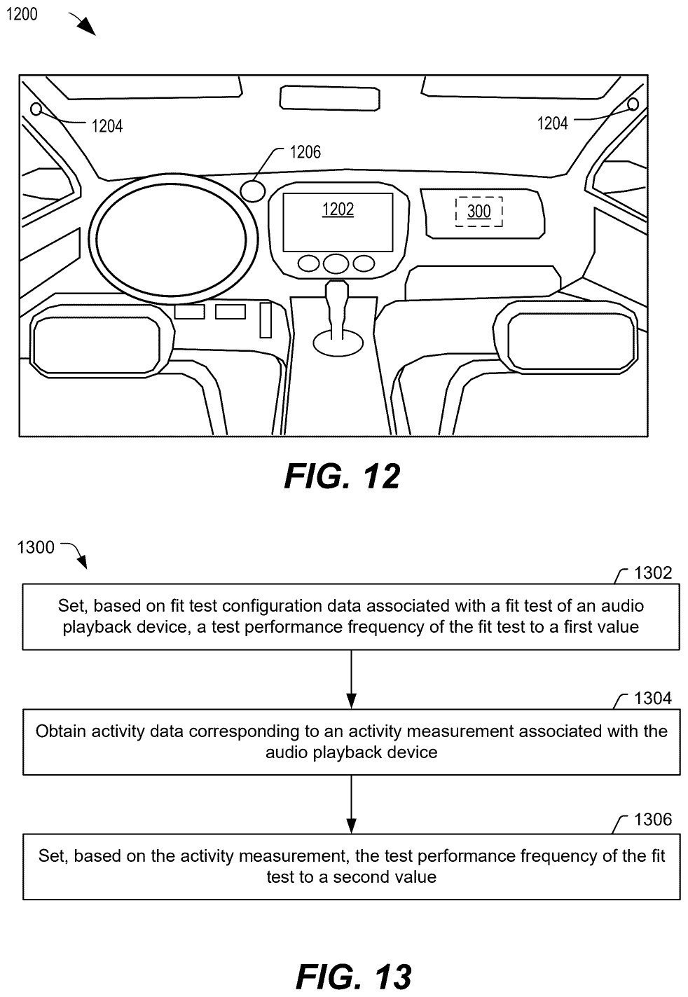

In some examples, the device 102 corresponds to or is included in one of various types of devices, such that the processor 108 can be integrated in multiple types of devices. In an illustrative example, the processor 108 is integrated in a wearable device, such as a headset as depicted in FIG. 5, a wearable electronic device as depicted in 6, a virtual reality, mixed reality, or augmented reality headset as depicted in FIG. 8, a mixed reality or augmented reality glasses device as described with reference to FIG. 9, earbuds as described with reference to FIG. 10, a hearing aid device as described with reference to FIG. 11, or another wearable device. In another illustrative example, the processor 108 is integrated in a mobile device (a mobile phone or a tablet) as depicted in FIG. 4, a voice-controlled speaker system as depicted in FIG. 7, a vehicle as depicted in FIG. 12, a computer or a server, or another system or device.

One technical advantage of implementing the device 102 as described above is that the device 102 is configured to perform a fit test that is associated with reduced power consumption as compared to other fit tests of other audio playback devices. To illustrate, in situations in which high levels of activity are detected by the activity sensor 114, the fit test manager 136 may set the test performance frequency 154 to a relatively high frequency, similar to other fit tests, in order to maintain the improved and user-specific audio experience associated with adjusting the equalizer 132 based on performance of the fit test. However, in situations in which lower levels of activity are detected by the activity sensor 114, the fit test manager 136 sets the test performance frequency 154 to a lower frequency to decrease the number of times the fit test is performed, thereby reducing power consumption associated with performance of the fit test. Selectively reducing the frequency of performance of the fit test slows power consumption of the battery 110, thereby improving the overall user experience by lengthening the time between charging, as well as providing the improved immersive audio experience of user-specific audio output levels that result from selective performance of the fit test by the device 102.

FIG. 2 includes a graph 220 of fit test performance and fit test configuration information 200, in accordance with some examples of the present disclosure. In some examples, the fit test described with reference to FIG. 2 is the fit test performed by the device 102 of FIG. 1 according to the test performance frequency 154, and the fit test configuration information 200 includes or corresponds to the fit test configuration data 140 of FIG. 1.

In some aspects, the fit test configuration information 200 includes multiple activity levels 202, multiple fit test performance frequencies 204, one or more activity thresholds 206, and optionally one or more power thresholds 208. In some aspects, the power thresholds 208 are not included in the fit test configuration information 200. In some alternate aspects, the activity levels 202 and the activity thresholds 206 are not included in the fit test configuration information 200. The activity levels 202 correspond to activity levels of the audio playback device (or the user wearing the audio playback device), and the fit test performance frequencies 204 correspond to fit test performance frequencies associated with each of the activity levels 202. In the example shown in FIG. 2, the activity levels 202 include a first activity level (“Level 0”) that corresponds to a first fit test performance frequency (once per 4000 ms), a second activity level (“Level 1”) that corresponds to a second fit test performance frequency (once per 3000 ms), a third activity level (“Level 2”) that corresponds to a third fit test performance frequency (once per 2000 ms), and a fourth activity level (“Level 3”) that corresponds to a fourth fit test performance frequency (once per 1000 ms). Although four activity levels and four fit test performance frequencies are shown in FIG. 2, in other examples, more than four or fewer than four activity levels and test performance frequencies may be included in the fit test configuration information 200. Additionally, the specific frequencies included in the fit test performance frequencies 204 are illustrative and, in other examples, the fit test performance frequencies 204 may include different frequencies than shown in FIG. 2.

The activity levels 202 are separated (e.g., bounded or distinguished) by the activity thresholds 206, and the power thresholds 208 indicate threshold power levels of a battery (e.g., the battery 110 of FIG. 1) that are associated with the respective activity levels and fit test frequency values. In the example shown in FIG. 2, the first activity level includes activity that is less than a first threshold (“TH_1”), the second activity level includes activity that is greater than or equal to the first threshold and that is less than a second threshold (“TH_2”), the third activity level includes activity that is greater than or equal to the second threshold and that is less than a third threshold (“TH_3”), and the fourth activity level includes activity that is greater than or equal to the third threshold. Although three activity thresholds are shown in FIG. 2, in other examples, more than three or less than three activity thresholds may be included in the fit test configuration information 200. As an illustrative example, the first activity level may correspond to activity within a first threshold range, the second activity level may correspond to activity within a second threshold range, the third activity level may correspond to activity within a third threshold range, and the fourth activity level may correspond to activity within a fourth threshold range. Also, in the example shown in FIG. 2, the second activity level, the third activity level, and the fourth activity level are associated with a power level that satisfies (e.g., is greater than or equal to) a power threshold (“TH_P”), and the first activity level is associated with a power level that fails to satisfy the power threshold. Although one power threshold is shown in FIG. 2, in other examples, more than one power threshold may be included in the fit test configuration information 200. It is to be noted that the values of the activity levels 202, the fit test performance frequencies 204, the activity thresholds 206, and the power thresholds 208 are illustrative and, in other examples, may be different values.

In some aspects, the activity sensor 114 is configured to detect real time, or near-real time, activity levels and motion patterns of the audio playback device (e.g., the device 102) or the user that is wearing the audio playback device, and this detected information can be conveyed to the fit test manager 136, such as via the application layer, to enable a determination of the frequency of repetition for the fit test (e.g., the test performance frequency 154). The fit test manager 136 may select an activity level indicated by the fit test configuration information 200 that matches the current activity level of the audio playback device as indicated by the activity data 150, and the test performance frequency 154 may be set to the respective fit test frequency value from the fit test configuration information 200. The test performance frequency 154 may be set to a lowest value during in situations in which the current activity level is a lowest activity level (e.g., when the device 102 or a user of the device 102 is stationary or nearly stationary), and the test performance frequency 154 may be set to increasingly higher values during the periods in which the current activity level is one of multiple increasingly higher activity levels (e.g., the second-fourth activity levels). In situations in which the current activity level is a highest activity level (e.g., when the device 102 or the user of the device 102 is moving or vibrating above multiple thresholds), the fit of the device 102 within or over the user's ear may become poor, and therefore the test performance frequency 154 is set at a highest value in the fit test configuration information 200. This dynamic adaptability of the frequency of repetition of the fit test performance, depending on the real time user activity and motion patterns, helps reduce the numbers of fit tests that are performed by the device 102, thereby helping to reduce power consumption (e.g., optimize battery power of the battery 110).

As an illustrative example, during a first time period, the activity data 150 may indicate a current activity level that is greater than or equal to the third activity threshold. Based on a comparison of the current activity level to the activity thresholds 206, the fit test manager 136 may determine that the device 102 is in the fourth activity level (“Level 3”) during the first time period, which corresponds to high activity. Accordingly, the fit test manager 136 may set the test performance frequency 154 to the fourth fit test frequency value, such that the fit test is performed once per 1000 ms during the first time period. This corresponds to the fit test being performed according to a first fit test frequency 222 in the graph 220 of FIG. 2. During a second time period, the activity data 150 may indicate that the current activity level is greater than or equal to the second activity threshold and less than the third activity threshold. Based on a comparison of the current activity level to the activity thresholds 206, the fit test manager 136 may determine that the device 102 is in the third activity level (“Level 2”) during the second time period. Accordingly, the fit test manager 136 may set the test performance frequency 154 to the third fit test frequency value, such that the fit test is performed once per 2000 ms during the second time period. This corresponds to the fit test being performed according to a second fit test frequency 224 in the graph 220 of FIG. 2. As shown from this example, the frequency of performing the fit test can be dynamically decreased to conserve power in situations when the fit is likely to be good or be dynamically increased to improve the quality of the audio output in situations when the fit is less likely to be good.

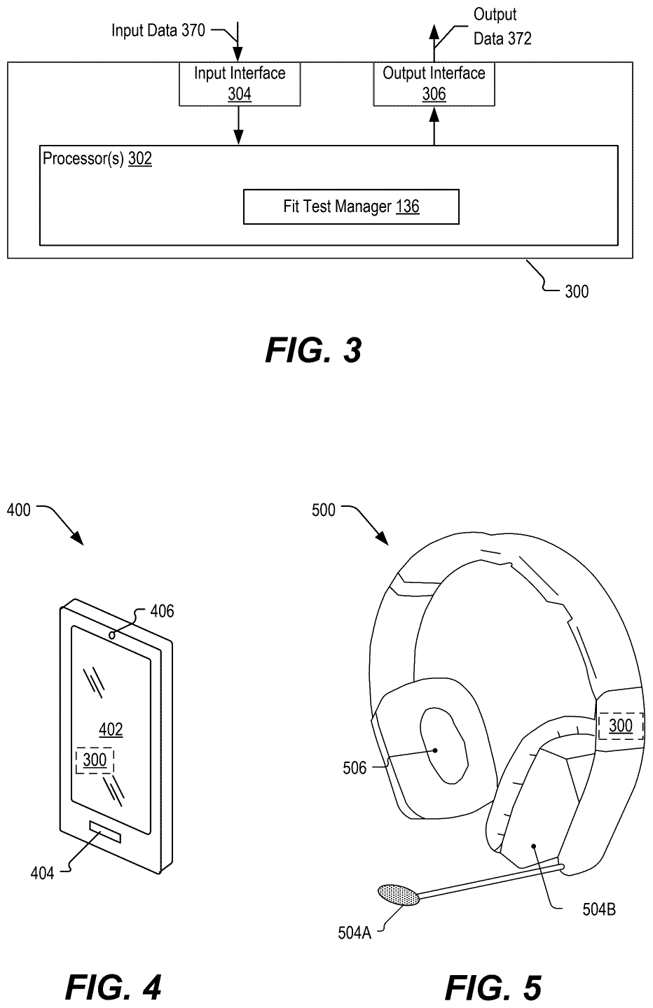

FIG. 3 depicts an example of an integrated circuit 300 operable to support activity-based fit test management, in accordance with some examples of the present disclosure. For example, the integrated circuit 300 may include the fit test manager 136 to support activity-based fit test management. The integrated circuit 300 may include or correspond to other devices described herein, such as the device 102 of FIG. 1, or the integrated circuit 300 may be included or integrated in other devices, such as described herein with reference to FIGS. 4-12.

The integrated circuit 300 includes one or more processors 302 (referred to hereinafter collectively as “the processor 302”) that include one or more components, such as the fit test manager 136. The integrated circuit 300 also includes an input interface 304, such as one or more bus interfaces, data interfaces, or the like, to enable the integrated circuit 300 to receive input data 370 for processing. For example, the input data 370 may include or represent the source data 152, the audio data 148, the activity data 150, the power indicator 146, or a combination thereof. The integrated circuit 300 also includes an output interface 306, such as one or more bus interfaces, data interfaces, or the like, to enable the integrated circuit 300 to cause output of output data 372 to another component or to be sent to another device. For example, the output data 372 can correspond to or include the output audio 156, the test performance frequency 154, or a combination thereof.

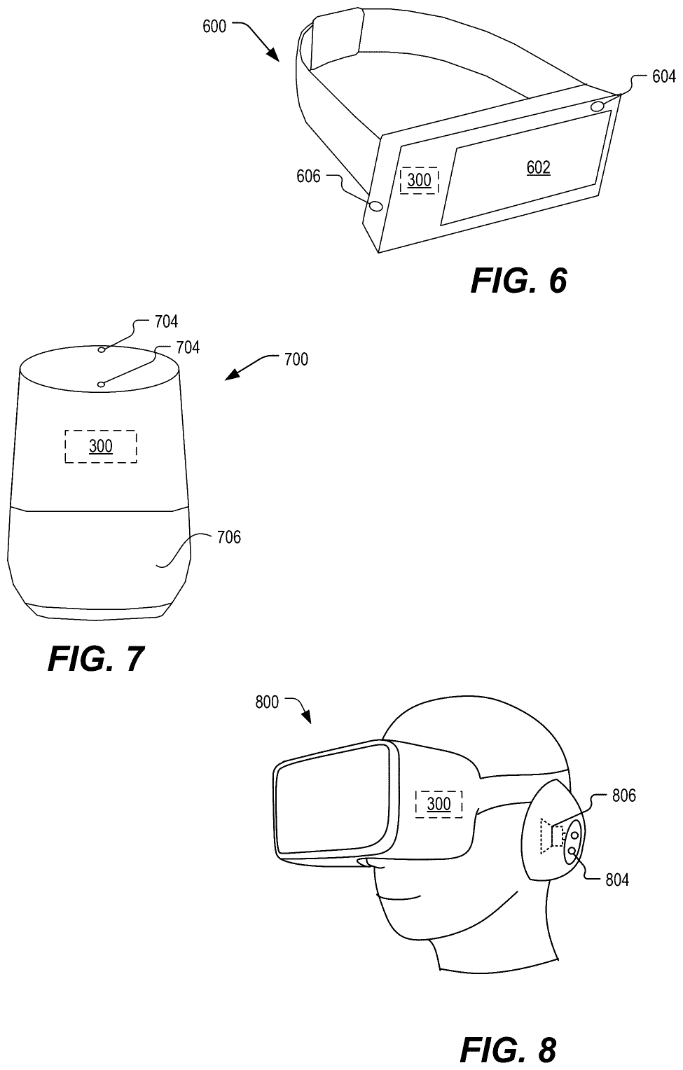

The integrated circuit 300 including the fit test manager 136 enables implementation of activity-based fit test management in a system or device, such as a mobile phone or tablet as depicted in FIG. 4, a headset as depicted in FIG. 5, a wearable electronic device as depicted in FIG. 6, a voice-controlled speaker system as depicted in FIG. 7, a virtual reality, mixed reality, or augmented reality headset as depicted in FIG. 8, a mixed reality or augmented reality glasses device as depicted in FIG. 9, earbuds as depicted in FIG. 10, a hearing aid device as depicted in FIG. 11 or a vehicle as depicted in FIG. 12. To illustrate, the integrated circuit 300 (e.g., the processor 302) is operable to receive activity data (e.g., included in the input data 370) that corresponds to an activity measurement associated with an audio playback device (e.g., the device in which the integrated circuit 300 is integrated or an external audio playback device that is communicatively coupled to the device in which the integrated circuit 300 is integrated). For example, the integrated circuit 300 may receive the activity data from an activity sensor of the device or from a modem or wireless interface that receives transmission(s) from the external audio playback device.

The integrated circuit 300 is also operable to set a test performance frequency (e.g., included in the output data 372), which may include or correspond to the test performance frequency 154, of a fit test associated with the audio playback device based on the activity measurement. For example, the fit test manager 136 (e.g., the processor 302) may set the test frequency to a value that corresponds to an activity level that is determined based on a comparison of the activity data to one or more thresholds (e.g., the thresholds 142). Accordingly, if activity of the audio playback device increases, and thus a fit of the audio playback device within or over the user's ear may change, the integrated circuit 300 may increase the test frequency to compensate for the potential changes to the fit. Alternatively, if the activity decreases, the integrated circuit 300 may decrease the test frequency to reduce power consumption of the audio playback device during times when the fit within or over the user's ear is less likely to change. The test frequency may be used by the integrated circuit 300 to initiate performance of a fit test based on audio data (e.g., included in the input data 370), or optionally, the test frequency may be output to a modem or wireless interface for transmission to an external audio playback device. Thus, setting the test frequency based on the activity measurement indicated by the activity data enables the integrated circuit 300 to reduce power consumption associated with the fit test by reducing the test performance frequency when decreased activity is measured.

FIG. 4 depicts an example of a mobile device 400 operable to support activity-based fit test management, in accordance with some examples of the present disclosure. The mobile device 400 may include a phone or tablet, as illustrative, non-limiting examples. The mobile device 400 includes a display screen 402, one or more microphones 404, and one or more speakers 406. In some examples, the display screen 402 includes a touch screen (e.g., a user interface) that is configured to receive user input, which may indicate a user-selected frequency value. The integrated circuit 300 is integrated in the mobile device 400 and is illustrated using dashed lines to indicate internal components that are not generally visible to a user of the mobile device 400. In a particular example, the integrated circuit 300 is operable to receive activity data that corresponds to an activity measurement associated with an audio playback device, such as an audio playback device that is communicatively coupled to the mobile device 400, and to set a test performance frequency of a fit test associated with the audio playback device based on the activity measurement. Setting the test performance frequency based on the activity measurement enables the mobile device 400 to reduce power consumption associated with the fit test by reducing the test performance frequency when decreased activity is measured. The mobile device 400 can also receive a power indicator associated with a battery of the audio playback device and set the test performance frequency based on the power indicator to reduce power consumption when a low power level is detected. In some examples, the integrated circuit 300 is also operable to obtain the user input received via the display screen 402 (e.g., a touch screen) or another user interface and to set the test performance frequency based on the user-selected frequency value indicated by the user input.

FIG. 5 depicts an example of a headset device 500 operable to support activity-based fit test management, in accordance with some examples of the present disclosure. The headset device 500 includes one or more microphones 504 and one or more speakers 506. In some examples, the headset device 500 includes one or more activity sensors (not shown). The integrated circuit 300 is integrated in the headset device 500 and is illustrated using dashed lines to indicate internal components that are not generally visible to a user of the headset device 500. In a particular example, the integrated circuit 300 is operable to obtain audio data representing sound captured by one or more of the microphone(s) 504 for use in performing a fit test for the headset device 500, obtain activity data from the one or more activity sensors that corresponds to an activity measurement associated with the headset device 500, and set a test performance frequency of the fit test based on the activity data. Setting the test performance frequency based on the activity measurement enables the headset device 500 to reduce power consumption associated with the fit test by reducing the test performance frequency when decreased activity is measured. The headset device 500 can also receive a power indicator associated with a battery of the audio playback device and set the test performance frequency based on the power indicator to reduce power consumption when a low power level is detected.

FIG. 6 depicts an example of a wearable electronic device 600 operable to support activity-based fit test management, in accordance with some examples of the present disclosure. The wearable electronic device 600, illustrated as a “smart watch” in FIG. 6, includes a display screen 602, one or more microphones 604, and one or more speakers 606. In some examples, the wearable electronic device 600 includes one or more activity sensor(s) (not shown). Alternatively, an audio playback device that is separate from the wearable electronic device 600 may include the activity sensor(s). The integrated circuit 300 is integrated in the wearable electronic device 600 and is illustrated using dashed lines to indicate internal components that are not generally visible to a user of the wearable electronic device 600. In a particular example, the integrated circuit 300 is operable to receive activity data (e.g., from activity sensor(s) included in the wearable electronic device 600 or via wireless communication from another device) that corresponds to an activity measurement associated with an audio playback device, such as an audio playback device that is communicatively coupled to the wearable electronic device 600, and to set a test performance frequency of a fit test associated with the audio playback device based on the activity measurement. Setting the test performance frequency based on the activity measurement enables the wearable electronic device 600 to reduce power consumption associated with the fit test by reducing the test performance frequency when decreased activity is measured. The wearable electronic device 600 can also receive a power indicator associated with a battery of the audio playback device and set the test performance frequency based on the power indicator to reduce power consumption when a low power level is detected. In some embodiments, the wearable electronic device 600 is configured to generate a notification based on the test performance frequency. For example, the display screen 602 can generate visual information based on the test performance frequency.

FIG. 7 depicts an example of a voice-controlled speaker system 700 operable to support activity-based fit test management, in accordance with some examples of the present disclosure. The voice-controlled speaker system 700 can have wireless network connectivity and is configured to execute an assistant operation. The voice-controlled speaker system 700 includes one or more microphones 704 and one or more speakers 706. The integrated circuit 300 is integrated in the voice-controlled speaker system 700 and is illustrated using dashed lines to indicate internal components that are not generally visible to a user of the voice-controlled speaker system 700. In a particular example, the integrated circuit 300 is operable to receive activity data that corresponds to an activity measurement associated with an audio playback device, such as an audio playback device that is communicatively coupled to the voice-controlled speaker system 700, and to set a test performance frequency of a fit test associated with the audio playback device based on the activity measurement. Setting the test performance frequency based on the activity measurement enables the voice-controlled speaker system 700 to reduce power consumption associated with the fit test by reducing the test performance frequency when decreased activity is measured. The voice-controlled speaker system 700 can also receive a power indicator associated with a battery of the audio playback device and set the test performance frequency based on the power indicator to reduce power consumption when a low power level is detected.

FIG. 8 depicts an example of a headset 800, such as a virtual reality, mixed reality, or augmented reality headset, operable to support activity-based fit test management, in accordance with some examples of the present disclosure. A visual interface device is positioned in front of the user's eyes to enable display of augmented reality, mixed reality, or virtual reality images or scenes to the user while the headset 800 is worn. The headset 800 also includes one or more microphones 804 and one or more speakers 806 (illustrated using dashed lines). In some examples, the headset device 500 includes one or more activity sensors (not shown). The integrated circuit 300 is integrated in the headset 800 and is illustrated using dashed lines to indicate internal components that are not generally visible to a user of the headset 800. In a particular example, the integrated circuit 300 is operable to obtain audio data representing sound captured by one or more of the microphone(s) 804 for use in performing a fit test for the headset 800, obtain activity data from the one or more activity sensors that corresponds to an activity measurement associated with the headset 800, and set a test performance frequency of the fit test based on the activity data. Setting the test performance frequency based on the activity measurement enables the headset 800 to reduce power consumption associated with the fit test by reducing the test performance frequency when decreased activity is measured. The headset 800 can also set the test performance frequency based on a power indicator associated with a battery of the headset 800 to reduce power consumption when a low power level is detected.

FIG. 9 depicts an example of a mixed reality or augmented reality glasses device 900 operable to support activity-based fit test management, in accordance with some examples of the present disclosure. The glasses device 900 includes a holographic projection unit 910 configured to project visual data onto a surface of a lens 902 or to reflect the visual data off of a surface of the lens 902 and onto the wearer's retina. The glasses device 900 also include one or more microphones 904 and one or more speakers 906 (using dashed lines). In some examples, the glasses device 900 includes one or more activity sensors (not shown). The integrated circuit 300 is integrated in the glasses device 900 and is illustrated using dashed lines to indicate internal components that are not generally visible to a user of the glasses device 900. In a particular example, the integrated circuit 300 is operable to obtain audio data representing sound captured by one or more of the microphone(s) 904 for use in performing a fit test for the glasses device 900, obtain activity data from the one or more activity sensors that corresponds to an activity measurement associated with the glasses device 900, and set a test performance frequency of the fit test based on the activity data. Setting the test performance frequency based on the activity measurement enables the glasses device 900 to reduce power consumption associated with the fit test by reducing the test performance frequency when decreased activity is measured. The glasses device 900 can also set the test performance frequency based on a power indicator associated with a battery of the glasses device 900 to reduce power consumption when a low power level is detected.

FIG. 10 depicts an example of earbuds 1000 operable to support activity-based fit test management, in accordance with some examples of the present disclosure. The earbuds 1000 include a first earbud 1002A and a second earbud 1002B, which can also be referred to as an earbud pair 1003. Although earbuds are described, it should be understood that the present technology can be applied to other in-ear or over-ear audio devices. Although two earbuds (e.g., the first earbud 1002A and the second earbud 1002B) are shown in FIG. 10, in other examples, the aspects described herein may be integrated into a single earbud.

The first earbud 1002A includes a first microphone 1004A, such as a high signal-to-noise microphone positioned to capture the voice of a wearer of the first earbud 1002A, an array of one or more other microphones configured to detect ambient sounds and spatially distributed to support beamforming, illustrated as microphone 1012A, an “inner” microphone 1014A proximate to the wearer's ear canal (e.g., to assist with active noise cancelling), and a self-speech microphone 1016A, such as a bone conduction microphone configured to convert sound vibrations of the wearer's ear bone or skull into an audio signal. The first earbud 1002A also includes one or more speakers 1006A. In some examples, the first earbud 1002A includes one or more activity sensors (not shown). The second earbud 1002B can be configured in a substantially similar manner as the first earbud 1002A. For example, the second earbud 1002B may include a first microphone 1004B, an array of one or more other microphones (illustrated as microphone 1012B), an “inner” microphone 1014B, a self-speech microphone 1016B, and one or more speakers 1006B. In some examples, the second earbud 1002B also includes one or more activity sensors (not shown). In some embodiments, the first earbud 1002A is also configured to receive one or more audio signals generated by one or more microphones of the second earbud 1002B, such as via wireless transmission between the first earbud 1002A and the second earbud 1002B, or via wired transmission in implementations in which the first earbud 1002A and the second earbud 1002B are coupled via a transmission line.

In some embodiments, the earbuds 1000 are configured to automatically switch between various operating modes, such as a passthrough mode in which ambient sound is played via the speakers 1006A, 1006B, a playback mode in which non-ambient sound (e.g., streaming audio corresponding to a phone conversation, media playback, a video game, etc.) is played back through the speakers 1006A, 1006B, and an audio zoom mode or beamforming mode in which one or more ambient sounds are emphasized and/or other ambient sounds are suppressed for playback at the speakers 1006A, 1006B. In other embodiments, the earbuds 1000 may support fewer modes or may support one or more other modes in place of, or in addition to, the described modes.

In an illustrative example, the earbuds 1000 can automatically transition from the playback mode to the passthrough mode in response to detecting the wearer's voice and may automatically transition back to the playback mode after the wearer has ceased speaking. In some examples, the earbuds 1000 can operate in two or more of the modes concurrently, such as by performing audio zoom on a particular ambient sound (e.g., a dog barking) and playing out the audio zoomed sound superimposed on the sound being played out while the wearer is listening to music (which can be reduced in volume while the audio zoomed sound is being played). In this example, the wearer can be alerted to the ambient sound associated with the audio event without halting playback of the music.

In FIG. 10, the integrated circuit 300 is integrated in the earbuds 1000 and is illustrated using dashed lines to indicate internal components that are not generally visible to a user of the earbuds 1000. For example, a first integrated circuit 300A may be integrated in the first earbud 1002A, and a second integrated circuit 300B may be integrated in the second earbud 1002B. In a particular example, the integrated circuits 300A, 300B are operable to obtain audio data representing sound captured by one or more of the microphone(s) 1004A, 1004B, 1012A, 1012B, 1014A, 1014B, 1016A, 1016B for use in performing a fit test for the earbuds 1000, obtain activity data from the one or more activity sensors that corresponds to an activity measurement associated with the earbuds 1000, and set a test performance frequency of the fit test based on the activity data. In some examples, the test performance frequency of the fit test may be set independently for each of the first earbud 1002A and the second earbud 1002B based on respective activity measurements, and equalizer settings determined during the respective fit tests may be different between the first earbud 1002A and the second earbud 1002B. Alternatively, the test performance frequencies, the equalizer settings, or both, may be set to a single value for both of the first earbud 1002A and the second earbud 1002B. Setting the test performance frequency based on the activity measurement enables the earbuds 1000 to reduce power consumption associated with the fit test by reducing the test performance frequency when decreased activity is measured.

The earbuds 1000 can also set the test performance frequency based on a power indicator associated with a battery of one, or both, of the earbuds 1000 to reduce power consumption when a low power level is detected. For example, the test performance frequency for the first earbud 1002A may be set based on a power indicator associated with a battery of the first earbud 1002A, and the test performance frequency for the second earbud 1002B may be set based on a power indicator associated with a battery of the second earbud 1002B. Alternatively, the test performance frequency may be set to a collective value for both the first earbud 1002A and the second earbud 1002B based on a power indicator associated with the battery of the first earbud 1002A, a power indicator associated with the battery of the second earbud 1002B, or both. For example, if the power indicator associated with either of the batteries indicates a power level that fails to satisfy a power threshold, the test performance frequency for the first earbud 1002A and the second earbud 1002B may set to a value associated with a low power level.

FIG. 11 depicts an example of a hearing aid device 1100 operable to support activity-based fit test management, in accordance with some examples of the present disclosure. In FIG. 11, the hearing aid device 1100 includes a housing 1110 including an over-ear portion 1114 configured to be worn over the ear of a user. An earpiece 1112 is coupled to the housing 1110 and includes one or more speakers 1106. In some embodiments, one or more microphones 1104 are disposed on the housing 1110. In some examples, the hearing aid device 1100 includes one or more activity sensors (not shown).

In FIG. 11, the integrated circuit 300 is integrated in the hearing aid device 1100 and is illustrated using dashed lines to indicate internal components that are not generally visible to a user of the hearing aid device 1100. In a particular example, the integrated circuit 300 is operable to obtain audio data representing sound captured by one or more of the microphone(s) 1104 for use in performing a fit test for the hearing aid device 1100, obtain activity data from the one or more activity sensors that corresponds to an activity measurement associated with the hearing aid device 1100 (e.g., the earpiece 1112), and set a test performance frequency of the fit test based on the activity data. Setting the test performance frequency based on the activity measurement enables the hearing aid device 1100 to reduce power consumption associated with the fit test by reducing the test performance frequency when decreased activity is measured. The hearing aid device 1100 can also set the test performance frequency based on a power indicator associated with a battery of the hearing aid device 1100 to reduce power consumption when a low power level is detected.

FIG. 12 depicts an example of a vehicle 1200 operable to support activity-based fit test management, in accordance with some examples of the present disclosure. The vehicle 1200, illustrated in FIG. 12 as a car, includes a display screen 1202, one or more microphones 1204, and one or more speakers 1206. The integrated circuit 300 is integrated in the vehicle 1200 and is illustrated using dashed lines to indicate internal components that are not generally visible to a user of the vehicle 1200. In a particular example, the integrated circuit 300 is operable to receive activity data that corresponds to an activity measurement associated with an audio playback device, such as an audio playback device that is communicatively coupled to the vehicle 1200, and to set a test performance frequency of a fit test associated with the audio playback device based on the activity measurement. Setting the test performance frequency based on the activity measurement enables the vehicle 1200 to reduce power consumption associated with the fit test by reducing the test performance frequency when decreased activity is measured. The vehicle 1200 can also receive a power indicator associated with a battery of the audio playback device and set the test performance frequency based on the power indicator to reduce power consumption when a low power level is detected.

Referring to FIG. 13, a particular example of a method 1300 of activity-based fit test management, in accordance with some examples of the present disclosure, is shown. In a particular aspect, one or more operations of the method 1300 are performed by the audio components 120, the decoder 130, the equalizer 132, the pre/post processors 134, the fit test manager 136, the processor 108, the device 102, the system 100 of FIG. 1, the integrated circuit 300 of FIGS. 3-12, the mobile device 400 of FIG. 4, the headset device 500 of FIG. 5, the wearable electronic device 600 of FIG. 6, the voice-controlled speaker system 700 of FIG. 7, the headset 800 of FIG. 8, the glasses device 900 of FIG. 9, the earbuds 1000 of FIG. 10, the hearing aid device 1100 of FIG. 11, the vehicle 1200 of FIG. 12, or a combination thereof.

In some embodiments, the method 1300 includes, at block 1302, setting, based on fit test configuration data associated with a fit test of an audio playback device, a test performance frequency of the fit test to a first value. For example, the fit test configuration data may include or correspond to the fit test configuration data 140 of FIG. 1, the test performance frequency may include or correspond to the test performance frequency 154 of FIG. 1, and the fit test manager 136 may set the test performance frequency 154 to a first value (e.g., an initial value or other value) based on the fit test configuration data 140. The fit test may be performed to determine or maintain a fit of the audio playback device (e.g., the device 102), such as an earbud or hearing aid device, within or over an ear of a user.

The method 1300 also includes, at block 1304, obtaining activity data corresponding to an activity measurement associated with the audio playback device. For example, the activity data may include or correspond to the activity data 150 of FIG. 1 that is obtained from the activity sensor 114 (or from the audio playback device in embodiments in which the audio playback device is communicatively coupled to the device 102).

The method 1300 includes, at block 1306, setting, based on the activity measurement, the test performance frequency of the fit test to a second value. For example, the fit test manager 136 may set the test performance frequency 154 of FIG. 1 to a second value based on an activity measurement indicated by, or derived from, the activity data 150.

In some embodiments, the method 1300 also includes receiving user input that indicates a user-selected frequency value and setting the test performance frequency of the fit test to the user-selected frequency value. For example, the device 102 of FIG. 1 may receive user input from another device via the wireless interface 116, or the device 102 may include a user interface that receives the user input, and the fit test manager 136 may set the test performance frequency 154 to a user-selected frequency value indicated by the user input. As another example, the mobile device 400 of FIG. 4 may receive the user input via the display screen 402 (e.g., a touch screen) or another user interface, and the integrated circuit 300 (e.g., the fit test manager 136) may set a fit test frequency for an audio playback device that is communicatively coupled to the mobile device 400 based on a user-selected frequency value indicated by the user input.

In some embodiments, the method 1300 also includes receiving data that indicates a power level of the audio playback device and setting, based on the power level, the test performance frequency of the fit test to a third value. For example, the data that indicates the power level may include or correspond to the power indicator 146 of FIG. 1, and the fit test manager 136 may set the test performance frequency 154 based on the power indicator 146, such as setting the test performance frequency 154 to a lower value if the power indicator 146 indicates that a power level of the device 102 is less than a threshold (e.g., one of the thresholds 142).

In some embodiments, the fit test configuration data indicates a plurality of test performance frequency values and a plurality of activity levels, and each test performance frequency value of the plurality of test performance frequency values is associated with a corresponding activity level of the plurality of activity levels. In some such embodiments, the method 1300 also includes comparing the activity measurement to one or more activity thresholds and selecting a current activity level from the plurality of activity levels based on the comparison. In such embodiments, the current activity level corresponds to a test performance frequency value of the plurality of test performance frequency values, and the second value is the test performance frequency value. For example, the fit test manager 136 may compare the activity level indicated by the activity data 150 to one or more of the thresholds 142 and, based on the comparison, select or identify a current activity level from the activity levels indicated by the fit test configuration data 140. To further illustrate, if the activity level satisfies a particular activity threshold or is within a particular activity threshold range, the fit test manager 136 may identify an activity level that is associated with the particular activity threshold or threshold range in the fit test configuration data 140, and the fit test manager 136 may set the test performance frequency 154 to the test performance frequency value that corresponds to the identified activity level, as indicated by the fit test configuration data 140, as also described herein with reference to FIG. 2.

In some embodiments, the method 1300 also includes obtaining audio data from a feedback microphone of the audio playback device, the audio data corresponding to a reference audio signal captured by the feedback microphone. For example, the audio data may include or correspond to the audio data 148 of FIG. 1 that is captured from the microphone 104, which in some embodiments includes a feedback microphone. The method 1300 also includes performing, during each of one or more time periods according to the test performance frequency, the fit test based on the audio data and the reference audio signal. For example, the audio components 120 (e.g., the decoder 130, the equalizer 132, and the pre/post processors 134) may perform a fit test using the source data 152 according to the test performance frequency 154 that is controlled by the fit test manager 136, and the source data 152 may include the audio data 148. In some such embodiments, the method 1300 also includes deactivating the feedback microphone, a fit test manager configured to manage the fit test, or both, for an idle time period between a first time period associated with a first performance of the fit test and a second time period associated with a second performance of the fit test. For example, the processor 108 may deactivate the microphone 104, the fit test manager 136, or both, for an idle time period between consecutive performances of the fit test.

In some embodiments, the audio playback device includes one or more activity sensors and the activity data includes sensor data output by the one or more activity sensors. For example, the activity sensors may include or correspond to the activity sensor 114 of FIG. 1. In some such embodiments, the method 1300 also includes periodically obtaining the activity data from the one or more activity sensors according to a polling schedule. For example, the processor 108 may periodically obtain the activity data 150 from the activity sensor 114 according to a polling schedule. Alternatively, the method 1300 may also include continuously obtaining the activity data from the one or more activity sensors during operation of the audio playback device.

One technical advantage of the method 1300 is that the method 1300 enables performance of a fit test that is associated with reduced power consumption as compared to other fit tests of other audio playback devices. To illustrate, in situations in which high levels of activity are detected, the method 1300 may set a test performance frequency of the fit test to a relatively high frequency, similar to other fit tests, in order to maintain the improved and user-specific audio experience associated with performance of the fit test. However, in situations in which lower levels of activity are detected, the method 1300 sets the test performance frequency to a lower frequency to decrease the number of times the fit test is performed, thereby reducing power consumption associated with performance of the fit test. Reducing the power consumption associated with the fit test increases the battery life of the audio playback device, thereby improving the overall user experience by lengthening the time between charging, as well as providing the improved immersive audio experience of user-specific audio output levels that result from selective performance of the fit test by the audio playback device.

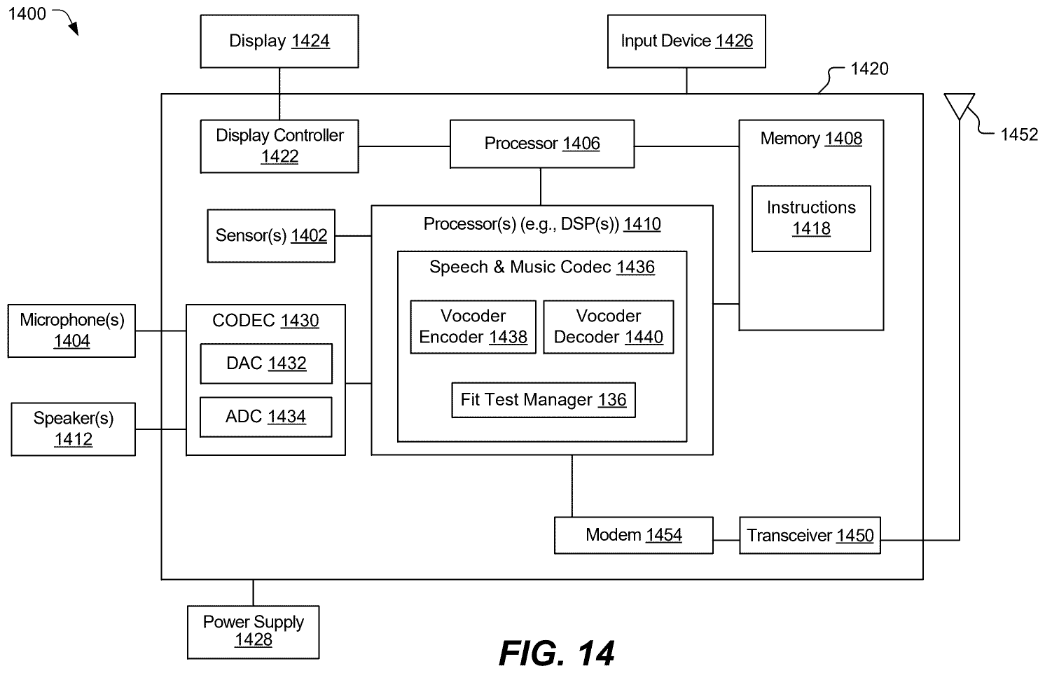

The method 1300 of FIG. 13 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1300 of FIG. 13 may be performed by a processor that executes instructions, such as described with reference to FIG. 14.

Referring to FIG. 14, a block diagram of a particular illustrative example of a device 1400 operable to support activity-based fit test management, in accordance with some examples of the present disclosure, is shown. In various embodiments, the device 1400 may have more or fewer components than illustrated in FIG. 14. In an illustrative example, the device 1400 may correspond to the device 102. In an illustrative embodiment, the device 1400 may perform one or more operations described with reference to FIGS. 1-13.

In a particular example, the device 1400 includes a processor 1406 (e.g., a CPU). The device 1400 may include one or more additional processors 1410 (e.g., one or more DSPs). In a particular aspect, the processor 108 of FIG. 1 corresponds to the processor 1406, the processors 1410, or a combination thereof. The processors 1410 may include a speech and music coder-decoder (CODEC) 1436 that includes a voice coder (“vocoder”) encoder 1438, a vocoder decoder 1440, the fit test manager 136, or a combination thereof. Although shown in FIG. 14 as being included in the speech and music CODEC 1436, in other examples, the fit test manager 136 is separate from the speech and music CODEC 1436. In some aspects, the device 1400 includes one or more sensors 1402 coupled to the processors 1410, such as one or more activity sensors. The sensor(s) 1402 may include an IMU, motion sensors, a bone conduction microphone, other activity sensors, or a combination thereof.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 1400 may include a memory 1408 and a CODEC 1430. In some examples, the memory 1408 may include or correspond to the memory 106 of FIG. 1 and include additional data, such as the fit test configuration data 140, the thresholds 142, or both. The memory 1408 may include instructions 1418, that are executable by the one or more additional processors 1410 (or the processor 1406) to implement the functionality described with reference to the fit test manager 136. In some example, the instructions 1418 may include or correspond to the instructions 144 of FIG. 1. The device 1400 may include a modem 1454 coupled, via a transceiver 1450, to an antenna 1452.

The device 1400 may include a display 1424 coupled to a display controller 1422. One or more speakers 1412 and one or more microphones 1404 may be coupled to the CODEC 1430. The CODEC 1430 may include a digital-to-analog converter (DAC) 1432, an analog-to-digital converter (ADC) 1434, or both. In a particular aspect, the CODEC 1430 may receive analog signals from the microphone(s) 1404, convert the analog signals to digital signals using the ADC 1434, and provide the digital signals to the speech and music CODEC 1436. The speech and music CODEC 1436 may process the digital signals, and the digital signals may further be processed by the fit test manager 136. In a particular aspect, the speech and music CODEC 1436 may provide digital signals to the CODEC 1430. The CODEC 1430 may convert the digital signals to analog signals using the DAC 1432 and may provide the analog signals to the speaker(s) 1412.

In a particular aspect, the device 1400 may be included in a system-in-package or system-on-chip device 1420. In a particular implementation, the memory 1408, the processor 1406, the processors 1410, the display controller 1422, the CODEC 1430, and the modem 1454 are included in the system-in-package or system-on-chip device 1420. In a particular implementation, an input device 1426 and a power supply 1428 are coupled to the system-in-package or the system-on-chip device 1420. Moreover, in a particular implementation, as illustrated in FIG. 14, the display 1424, the input device 1426, the speaker(s) 1412, the microphone(s) 1404, the antenna 1452, and the power supply 1428 are external to the system-in-package or the system-on-chip device 1420. In a particular aspect, each of the display 1424, the input device 1426, the speaker(s) 1412, the microphone(s) 1404, the antenna 1452, and the power supply 1428 may be coupled to a component of the system-in-package or the system-on-chip device 1420, such as an interface or a controller.

The device 1400 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for setting, based on fit test configuration data associated with a fit test of an audio playback device, a test performance frequency of the fit test to a first value. For example, the means for setting can include the fit test manager 136, the audio components 120, the processor 108, the device 102, the system 100, the integrated circuit 300, a device of FIGS. 4-12, the processor 1406, the processor(s) 1410, the system-in-package or the system-on-chip device 1420, the device 1400, other circuitry configured to set a test performance frequency of a fit test to a first value based on fit test configuration data associated with the fit test of an audio playback device, or a combination thereof.

The apparatus also includes means for obtaining activity data corresponding to an activity measurement associated with the audio playback device. For example, the means for obtaining can include the activity sensor 114, the processor 108, the device 102, the system 100, the integrated circuit 300, a device of FIGS. 4-12, the processor 1406, the processor(s) 1410, the system-in-package or the system-on-chip device 1420, the device 1400, other circuitry configured to obtain activity data corresponding to an activity measurement associated with an audio playback device, or a combination thereof.

The apparatus includes means for setting, based on the activity measurement, the test performance frequency of the fit test to a second value. For example, the means for setting can include the fit test manager 136, the audio components 120, the processor 108, the device 102, the system 100, the integrated circuit 300, a device of FIGS. 4-12, the processor 1406, the processor(s) 1410, the system-in-package or the system-on-chip device 1420, the device 1400, other circuitry configured to set the test performance frequency to a second value based on the activity measurement, or a combination thereof.

In some implementations, a non-transitory computer-readable medium (e.g., a computer-readable storage device, such as the memory 106 or the memory 1408) includes instructions (e.g., the instructions 144 or the instructions 1418) that, when executed by one or more processors (e.g., the processor 108, the one or more processors 1410 or the processor 1406), cause the one or more processors to set, based on fit test configuration data (e.g., the fit test configuration data 140) associated with a fit test of an audio playback device (e.g., the device 102, an audio playback device coupled to the device 102, the device 1400, or an audio playback device coupled to the device 1400), a test performance frequency (e.g., the test performance frequency 154) of the fit test to a first value. The instructions also cause the one or more processors to obtain activity data (e.g., the activity data 150) corresponding to an activity measurement associated with the audio playback device. The instructions also cause the one or more processors to set, based on the activity measurement, the test performance frequency of the fit test to a second value.

Particular aspects of the disclosure are described below in sets of interrelated Examples:

According to Example 1, a device includes: a memory configured to store fit test configuration data associated with a fit test of an audio playback device; and one or more processors coupled to the memory, wherein the one or more processors are configured to: set, based on the fit test configuration data, a test performance frequency of the fit test to a first value; obtain activity data corresponding to an activity measurement associated with the audio playback device; and set, based on the activity measurement, the test performance frequency of the fit test to a second value.

Example 2 includes the device of Example 1, wherein: the fit test configuration data indicates a plurality of test performance frequency values and a plurality of activity levels; and each test performance frequency value of the plurality of test performance frequency values is associated with a corresponding activity level of the plurality of activity levels.

Example 3 includes the device of Example 2, wherein the one or more processors are configured to: compare the activity measurement to one or more activity thresholds; and select a current activity level from the plurality of activity levels based on the comparison, wherein the current activity level corresponds to a test performance frequency value of the plurality of test performance frequency values, and wherein the second value is the test performance frequency value.

Example 4 includes the device of Example 2 or Example 3, wherein: the plurality of test performance frequency values includes at least a first test performance frequency value associated with a first activity level and a second test performance frequency value associated with a second activity level; the second test performance frequency value is less than the first test performance frequency value; and the first activity level is greater than the second activity level.

Example 5 includes the device of any of Examples 1 to 4, wherein the one or more processors are configured to: obtain audio data from a feedback microphone of the audio playback device, the audio data corresponding to a reference audio signal captured by the feedback microphone; and perform, during each of one or more time periods according to the test performance frequency, the fit test based on the audio data and the reference audio signal.

Example 6 includes the device of Example 5, wherein the one or more time periods include at least a first time period associated with a first performance of the fit test and a second time period associated with a second performance of the fit test, and wherein the one or more processors are configured to: deactivate the feedback microphone, a fit test manager configured to manage the fit test, or both, for an idle time period between the first time period and the second time period.

Example 7 includes the device of any of Examples 1 to 6, wherein the audio playback device includes one or more activity sensors, and wherein the activity data includes sensor data output by the one or more activity sensors.

Example 8 includes the device of Example 7, wherein the one or more activity sensors include an inertial measurement unit (IMU), and wherein the activity data includes motion data output by the IMU.

Example 9 includes the device of Example 7 or Example 8, wherein: the one or more activity sensors include a bone conduction microphone; the activity data includes audio data that is output by the bone conduction microphone; and the audio data indicates vibrations that correspond to motion of the audio playback device.

Example 10 includes the device of any of Examples 7 to 9, wherein the one or more processors are configured to continuously obtain the activity data from the one or more activity sensors during operation of the audio playback device.

Example 11 includes the device of any of Examples 7 to 9, wherein the one or more processors are configured to periodically obtain the activity data from the one or more activity sensors according to a polling schedule.

Example 12 includes the device of any of Examples 1 to 11 and further includes a wireless interface configured to receive the activity data from the audio playback device.

Example 13 includes the device of any of Examples 1 to 12, wherein the audio playback device includes one or more earbud devices, and wherein the fit test is configured to test a fit of the one or more earbud devices in one or more ears of a user.

Example 14 includes the device of any of Examples 1 to 12, wherein the one or more processors are integrated in a headset device, wherein the audio playback device includes the headset device, and further includes: one or more microphones coupled to the one or more processors and configured to capture one or more audio signals, wherein performance of the fit test is based on the one or more audio signals.

Example 15 includes the device of any of Examples 1 to 12, wherein the one or more processors are integrated in a headset device, wherein the audio playback device includes the headset device, and further includes: one or more speakers configured to generate a reference audio output, wherein the performance of the fit test is based on the reference audio output.

Example 16 includes the device of any of Examples 1 to 12, wherein the one or more processors are integrated in at least one of a mobile phone, a tablet computer device, or a wearable electronic device, and wherein the audio playback device is distinct from the mobile phone, the tablet computer device, or the wearable electronic device.

Example 17 includes the device of any of Examples 1 to 12, wherein the one or more processors are integrated in a vehicle, and wherein the audio playback device is distinct from the vehicle.

According to Example 18, a method includes: setting, by one or more processors and based on fit test configuration data associated with a fit test of an audio playback device, a test performance frequency of the fit test to a first value; obtaining, by the one or more processors, activity data corresponding to an activity measurement associated with the audio playback device; and setting, by the one or more processors based on the activity measurement, the test performance frequency of the fit test to a second value.

Example 19 includes the method of Example 18, and the method further includes: receiving, by the one or more processors, user input that indicates a user-selected frequency value; and setting the test performance frequency of the fit test to the user-selected frequency value.

Example 20 includes the method of Example 18 or Example 19, and the method further includes: receiving, by the one or more processors, data that indicates a power level of the audio playback device; and setting, based on the power level, the test performance frequency of the fit test to a third value.

Example 21 includes the method of Example 18, and the method further includes: receiving, by the one or more processors, user input that indicates a user-selected frequency value or data that indicates a power level of the audio playback device; and setting, based on the power level, the test performance frequency of the fit test to a third value or setting the test performance frequency of the fit test to the user-selected frequency value.

Example 22 includes the method of any of Examples 18 to 21, wherein: the fit test configuration data indicates a plurality of test performance frequency values and a plurality of activity levels; and each test performance frequency value of the plurality of test performance frequency values is associated with a corresponding activity level of the plurality of activity levels.

Example 23 includes the method of Example 22, and the method further includes: comparing the activity measurement to one or more activity thresholds; and selecting a current activity level from the plurality of activity levels based on the comparison, wherein the current activity level corresponds to a test performance frequency value of the plurality of test performance frequency values, and wherein the second value is the test performance frequency value.

Example 24 includes the method of Example 22 or Example 23, wherein: the plurality of test performance frequency values includes at least a first test performance frequency value associated with a first activity level and a second test performance frequency value associated with a second activity level; the second test performance frequency value is less than the first test performance frequency value; and the first activity level is greater than the second activity level.

Example 25 includes the method of any of Examples 18 to 24, and the method further includes: obtaining audio data from a feedback microphone of the audio playback device, the audio data corresponding to a reference audio signal captured by the feedback microphone; and performing, during each of one or more time periods according to the test performance frequency, the fit test based on the audio data and the reference audio signal.

Example 26 includes the method of Example 25, wherein the one or more time periods include at least a first time period associated with a first performance of the fit test and a second time period associated with a second performance of the fit test, and the method further includes: deactivating the feedback microphone, a fit test manager configured to manage the fit test, or both, for an idle time period between the first time period and the second time period.

Example 27 includes the method of any of Examples 18 to 26, wherein the audio playback device includes one or more activity sensors, and wherein the activity data includes sensor data output by the one or more activity sensors.

Example 28 includes the method of Example 27, wherein the one or more activity sensors include an inertial measurement unit (IMU), and wherein the activity data includes motion data output by the IMU.

Example 29 includes the method of Example 27 or Example 28, wherein: the one or more activity sensors include a bone conduction microphone; the activity data includes audio data that is output by the bone conduction microphone; and the audio data indicates vibrations that correspond to motion of the audio playback device.

Example 30 includes the method of any of Examples 27 to 29, and the method further includes continuously obtaining the activity data from the one or more activity sensors during operation of the audio playback device.

Example 31 includes the method of any of Examples 27 to 29, and the method further includes periodically obtaining the activity data from the one or more activity sensors according to a polling schedule.

Example 32 includes the method of any of Examples 18 to 31, wherein the audio playback device includes one or more earbud devices, and wherein the fit test is configured to test a fit of the one or more earbud devices in one or more ears of a user.

According to Example 33, a non-transitory, computer-readable medium storing instructions that are executable by one or more processors to cause the one or more processors to: set, based on fit test configuration data associated with a fit test of an audio playback device, a test performance frequency of the fit test to a first value; obtain activity data corresponding to an activity measurement associated with the audio playback device; and set, based on the activity measurement, the test performance frequency of the fit test to a second value.

Example 34 includes the non-transitory, computer-readable medium of Example 33, wherein the instructions are executable by the one or more processors to cause the one or more processors to: receive user input that indicates a user-selected frequency value; and set the test performance frequency of the fit test to the user-selected frequency value.

Example 35 includes the non-transitory, computer-readable medium of Example 33 or Example 34, wherein the instructions are executable by the one or more processors to cause the one or more processors to: receive data that indicates a power level of the audio playback device; and set, based on the power level, the test performance frequency of the fit test to a third value.

Example 36 includes the non-transitory, computer-readable medium of any of Examples 33 to 35, wherein: the fit test configuration data indicates a plurality of test performance frequency values and a plurality of activity levels; and each test performance frequency value of the plurality of test performance frequency values is associated with a corresponding activity level of the plurality of activity levels.

Example 37 includes the non-transitory, computer-readable medium of Example 36, wherein the instructions are executable by the one or more processors to cause the one or more processors to: compare the activity measurement to one or more activity thresholds; and select a current activity level from the plurality of activity levels based on the comparison, wherein the current activity level corresponds to a test performance frequency value of the plurality of test performance frequency values, and wherein the second value is the test performance frequency value.

Example 38 includes the non-transitory, computer-readable medium of Example 36 or Example 37, wherein: the plurality of test performance frequency values includes at least a first test performance frequency value associated with a first activity level and a second test performance frequency value associated with a second activity level; the second test performance frequency value is less than the first test performance frequency value; and the first activity level is greater than the second activity level.

Example 39 includes the non-transitory, computer-readable medium of any of Examples 33 to 38, wherein the instructions are executable by the one or more processors to cause the one or more processors to: obtain audio data from a feedback microphone of the audio playback device, the audio data corresponding to a reference audio signal captured by the feedback microphone; and perform, during each of one or more time periods according to the test performance frequency, the fit test based on the audio data and the reference audio signal.

Example 40 includes the non-transitory, computer-readable medium of Example 39, wherein the one or more time periods include at least a first time period associated with a first performance of the fit test and a second time period associated with a second performance of the fit test, and wherein the instructions are executable by the one or more processors to cause the one or more processors to: deactivate the feedback microphone, a fit test manager configured to manage the fit test, or both, for an idle time period between the first time period and the second time period.

Example 41 includes the non-transitory, computer-readable medium of any of Examples 33 to 40, wherein the audio playback device includes one or more activity sensors, and wherein the activity data includes sensor data output by the one or more activity sensors.

Example 42 includes the non-transitory, computer-readable medium of Example 41, wherein the one or more activity sensors include an inertial measurement unit (IMU), and wherein the activity data includes motion data output by the IMU.

Example 43 includes the non-transitory, computer-readable medium of Example 41 or Example 42, wherein: the one or more activity sensors include a bone conduction microphone; the activity data includes audio data that is output by the bone conduction microphone; and the audio data indicates vibrations that correspond to motion of the audio playback device.

Example 44 includes the non-transitory, computer-readable medium of any of Examples 41 to 43, wherein the instructions are executable by the one or more processors to cause the one or more processors to continuously obtain the activity data from the one or more activity sensors during operation of the audio playback device.

Example 45 includes the non-transitory, computer-readable medium of any of Examples 41 to 43, wherein the instructions are executable by the one or more processors to cause the one or more processors to periodically obtain the activity data from the one or more activity sensors according to a polling schedule.

Example 46 includes the non-transitory, computer-readable medium of any of Examples 33 to 45, wherein the audio playback device includes one or more earbud devices, and wherein the fit test is configured to test a fit of the one or more earbud devices in one or more ears of a user.

According to Example 47, an apparatus includes: means for setting, based on fit test configuration data associated with a fit test of an audio playback device, a test performance frequency of the fit test to a first value; means for obtaining activity data corresponding to an activity measurement associated with the audio playback device; and means for setting, based on the activity measurement, the test performance frequency of the fit test to a second value.

Example 48 includes the apparatus of Example 47, and the apparatus further includes: means for receiving user input that indicates a user-selected frequency value; and means for setting the test performance frequency of the fit test to the user-selected frequency value.

Example 49 includes the apparatus of Example 47 or Example 48, and the apparatus further includes: means for receiving data that indicates a power level of the audio playback device; and means for setting, based on the power level, the test performance frequency of the fit test to a third value.

Example 50 includes the apparatus of any of Examples 47 to 49, wherein: the fit test configuration data indicates a plurality of test performance frequency values and a plurality of activity levels; and each test performance frequency value of the plurality of test performance frequency values is associated with a corresponding activity level of the plurality of activity levels.

Example 51 includes the apparatus of Example 50, and the apparatus further includes: means for comparing the activity measurement to one or more activity thresholds; and means for selecting a current activity level from the plurality of activity levels based on the comparison, wherein the current activity level corresponds to a test performance frequency value of the plurality of test performance frequency values, and wherein the second value is the test performance frequency value.

Example 52 includes the apparatus of Example 50 or Example 51, wherein: the plurality of test performance frequency values includes at least a first test performance frequency value associated with a first activity level and a second test performance frequency value associated with a second activity level; the second test performance frequency value is less than the first test performance frequency value; and the first activity level is greater than the second activity level.

Example 53 includes the apparatus of any of Examples 47 to 52, and the apparatus further includes: means for obtaining audio data from a feedback microphone of the audio playback device, the audio data corresponding to a reference audio signal captured by the feedback microphone; and means for performing, during each of one or more time periods according to the test performance frequency, the fit test based on the audio data and the reference audio signal.

Example 54 includes the apparatus of Example 53, wherein the one or more time periods include at least a first time period associated with a first performance of the fit test and a second time period associated with a second performance of the fit test, and the apparatus further includes: means for deactivating the feedback microphone, a fit test manager configured to manage the fit test, or both, for an idle time period between the first time period and the second time period.

Example 55 includes the apparatus of any of Examples 47 to 54, wherein the audio playback device includes one or more activity sensors, and wherein the activity data includes sensor data output by the one or more activity sensors.

Example 56 includes the apparatus of Example 55, wherein the one or more activity sensors include an inertial measurement unit (IMU), and wherein the activity data includes motion data output by the IMU.

Example 57 includes the apparatus of Example 55 or Example 56, wherein: the one or more activity sensors include a bone conduction microphone; the activity data includes audio data that is output by the bone conduction microphone; and the audio data indicates vibrations that correspond to motion of the audio playback device.

Example 58 includes the apparatus of any of Examples 55 to 57 and further includes means for continuously obtaining the activity data from the one or more activity sensors during operation of the audio playback device.

Example 59 includes the apparatus of any of Examples 55 to 57, and the apparatus further includes means for periodically obtaining the activity data from the one or more activity sensors according to a polling schedule.

Example 60 includes the apparatus of any of Examples 47 to 59, wherein the audio playback device includes one or more earbud devices, and wherein the fit test is configured to test a fit of the one or more earbud devices in one or more ears of a user.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store fit test configuration data associated with a fit test of an audio playback device; and
one or more processors coupled to the memory, wherein the one or more processors are configured to:
set, based on the fit test configuration data, a test performance frequency of the fit test to a first value;
obtain activity data corresponding to an activity measurement associated with the audio playback device; and
set, based on the activity measurement, the test performance frequency of the fit test to a second value.

2. The device of claim 1, wherein:
the fit test configuration data indicates a plurality of test performance frequency values and a plurality of activity levels; and
each test performance frequency value of the plurality of test performance frequency values is associated with a corresponding activity level of the plurality of activity levels.

3. The device of claim 2, wherein the one or more processors are configured to:
compare the activity measurement to one or more activity thresholds; and
select a current activity level from the plurality of activity levels based on the comparison, wherein the current activity level corresponds to a test performance frequency value of the plurality of test performance frequency values, and wherein the second value is the test performance frequency value.

4. The device of claim 2, wherein:
the plurality of test performance frequency values includes at least a first test performance frequency value associated with a first activity level and a second test performance frequency value associated with a second activity level;
the second test performance frequency value is less than the first test performance frequency value; and
the first activity level is greater than the second activity level.

5. The device of claim 1, wherein the one or more processors are configured to:
obtain audio data from a feedback microphone of the audio playback device, the audio data corresponding to a reference audio signal captured by the feedback microphone; and
perform, during each of one or more time periods according to the test performance frequency, the fit test based on the audio data and the reference audio signal.

6. The device of claim 5, wherein the one or more time periods include at least a first time period associated with a first performance of the fit test and a second time period associated with a second performance of the fit test, and wherein the one or more processors are configured to:
deactivate the feedback microphone, a fit test manager configured to manage the fit test, or both, for an idle time period between the first time period and the second time period.

7. The device of claim 1, wherein the audio playback device comprises one or more activity sensors, and wherein the activity data includes sensor data output by the one or more activity sensors.

8. The device of claim 7, wherein the one or more activity sensors include an inertial measurement unit (IMU), and wherein the activity data includes motion data output by the IMU.

9. The device of claim 7, wherein:
the one or more activity sensors include a bone conduction microphone;
the activity data includes audio data that is output by the bone conduction microphone; and
the audio data indicates vibrations that correspond to motion of the audio playback device.

10. The device of claim 7, wherein the one or more processors are configured to continuously obtain the activity data from the one or more activity sensors during operation of the audio playback device.

11. The device of claim 7, wherein the one or more processors are configured to periodically obtain the activity data from the one or more activity sensors according to a polling schedule.

12. The device of claim 1, further comprising a wireless interface configured to receive the activity data from the audio playback device.

13. The device of claim 1, wherein the audio playback device includes one or more earbud devices, and wherein the fit test is configured to test a fit of the one or more earbud devices in one or more ears of a user.

14. The device of claim 1, wherein the one or more processors are integrated in a headset device, wherein the audio playback device comprises the headset device, and further comprising:
one or more microphones coupled to the one or more processors and configured to capture one or more audio signals, wherein performance of the fit test is based on the one or more audio signals.

15. The device of claim 1, wherein the one or more processors are integrated in a headset device, wherein the audio playback device comprises the headset device, and further comprising:
one or more speakers configured to generate a reference audio output, wherein the performance of the fit test is based on the reference audio output.

16. The device of claim 1, wherein the one or more processors are integrated in at least one of a mobile phone, a tablet computer device, or a wearable electronic device, and wherein the audio playback device is distinct from the mobile phone, the tablet computer device, or the wearable electronic device.

17. The device of claim 1, wherein the one or more processors are integrated in a vehicle, and wherein the audio playback device is distinct from the vehicle.

18. A method comprising:
setting, by one or more processors based on fit test configuration data associated with a fit test of an audio playback device, a test performance frequency of the fit test to a first value;
obtaining, by the one or more processors, activity data corresponding to an activity measurement associated with the audio playback device; and
setting, by the one or more processors based on the activity measurement, the test performance frequency of the fit test to a second value.

19. The method of claim 18, further comprising:
receiving, by the one or more processors, user input that indicates a user-selected frequency value or data that indicates a power level of the audio playback device; and
setting, based on the power level, the test performance frequency of the fit test to a third value or setting the test performance frequency of the fit test to the user-selected frequency value.

20. A non-transitory, computer-readable medium storing instructions that are executable by one or more processors to cause the one or more processors to:
set, based on fit test configuration data associated with a fit test of an audio playback device, a test performance frequency of the fit test to a first value;
obtain activity data corresponding to an activity measurement associated with the audio playback device; and
set, based on the activity measurement, the test performance frequency of the fit test to a second value.
